(19) United States
(12) Patent Application Publication
(10) Pub. No.: US 2013/0135588 A1
(43) Pub. Date: May 30, 2013

(54) 3D display apparatus

(71) Applicants: Milan Momcilo Popovich, Leicester (GB); Jonathan David Waldern, Los Altos Hills, CA (US)

(72) Inventors: Milan Momcilo Popovich, Leicester (GB); Jonathan David Waldern, Los Altos Hills, CA (US)

(21) Appl. No.: 13/373,754

(22) Filed: Nov. 29, 2011

(51) Int. Cl. G02B 27/26; G02B 27/48; G03B 21/28; G02B 27/28; G03B 21/14

(52) U.S. Cl. 353/8; 359/489.08; 359/465

(57) ABSTRACT

A 3D display is provided comprising at least one light source, a Switchable Bragg Grating device, a microdisplay and a projection lens system. In one embodiment of the invention the SBG device converts the source light into colour sequential illumination and, and provides sequential orthogonally polarized illumination of the microdisplay for each colour. In one embodiment of the invention the first SBG device converts the source light into colour sequential illumination and, and provides sequential first and second sense circularly polarized illumination. The microdisplay is updated with alternating left and right eye perspective images for stereoscopic viewing.

### REFERENCE TO PRIORITY APPLICATION

This application claims the priority of U.S. Provisional Patent Application No. 61/213,303 filed on 28 May 2009.

### REFERENCE TO EARLIER APPLICATIONS

This application incorporates by reference in their entireties U.S. Pat. No. 6,115,152, issued 5 Sep. 2000 entitled “HOLOGRAPHIC ILLUMINATION SYSTEM”; the PCT application: PCT/US2006/041689 entitled “COMPACT HOLOGRAPHIC ILLUMINATION DEVICE” with international filing date 27 Oct. 2006; and PCT application PCT/IB2008/0019099 with International Filing date 22 Jul. 2008 entitled LASER ILLUMINATION DEVICES”.

### BACKGROUND OF THE INVENTION

This invention relates to 3D visual displays and more specifically to an apparatus for providing left and right eye illumination for a 3D display.

Three-dimensional image displays create the illusion of depth by providing a slightly different perspective image to each eye. The brain fuses the images to create a three dimensional images. The left and right images are provided by displays such as Liquid Crystal Displays (LCDs). Typically, the viewer uses a single display panel with left and right eye images being displayed in alternated frames. The glasses contain means for selectively viewing the left and right eye images. Many different optical principles have been applied in 3D glasses. Liquid Crystal shutter glasses provide shutters that use the polarising properties of liquid crystal.

In another type of display two images are projected superimposed onto the same screen through orthogonal polarizing filters. Typically a silver screen is used so that polarization is preserved. The viewer wears low-cost eyeglasses which also contain a pair of orthogonal polarizing filters. As each filter only passes light which is similarly polarized and blocks the orthogonally polarized light, each eye only sees one of the images. Linearly polarized glasses suffer from the problem that the viewer's head must be kept level to avoid tilting of the viewing filters causing left and right images images to bleed over to the opposite channel. Such schemes allow several people to view the stereocopic images at the same time.

In another polarization-based 3D viewer, two images are projected superimposed onto the same screen through quarter wave plate (QWP) filters of opposite handedness. The viewer wears low-cost eyeglasses which contain a pair of analyzing filters (circular polarizers mounted in reverse) of opposite handedness. Light that is left-circularly polarized is extinguished by the right-handed analyzer; while right-circularly polarized light is extinguished by the left-handed analyzer. The result is similar to that of stereoscopic viewing using linearly polarized glasses; except the viewer can tilt his head and still maintain left/right separation.

Three-dimensional displays have many applications. With the growing trend towards globally dispersed workforces there is a need for communication systems than allow remote participants to interact as if present at a location other than their true location. Traditional audio visual communication systems such as video conferencing suffer from the problem that cameras, monitors, electrical cabling and other equipment provide an unnatural environment that is not invisible enough to allow relaxed human-to-human communication and efficient performance of computer-based tasks. The imagery often suffers from poor resolution, inadequate brightness, and small fields of view. Image latency is a further problem. There is a requirement for distributed work stations that allow workers to collaborate efficiently and spontaneously while retaining a high degree of individual and group identity.

The technologies being developed to overcome the above problems are usually referred to as telepresence and comprise technologies for the sensing, transmission and replication at remote locations of user's position, movements, actions, voice and other parameters. Visual feedback is arguably the most important important aspect of telepresence. An ideal display should provide a panoramic field of view of at least ninety degrees, allowing the user to look left and right to address co-participants combined with directional eye-to-eye imaging to allow more intimate one-to-one scale interaction. Essentially, the imagery should be stereoscopic, in full colour and should be seamless without any visual artifacts that might interrupt the telepresence illusion. Ideally, the viewpoint follows the movement and orientation of the user's head. In order to achieve this, the user may be provided with either a very large (or wraparound) screen, or small displays mounted directly in front of the eyes. For a convincing 3D sensation the movements of the user's head must be sensed, and the camera must mimic those movements accurately and in real time. Accurate tracking is essential to prevent motion sickness. Visual latency should be almost unperceivable. Ideally, resolution should be high enough to reveal skin texture. Lighting should provide a close match to ambient settings with high contrast and minimal shadow intrusion.

The prior art suffers from the problem of poor optical transmission, viewing discomfort and the cost and complexity of the optical components used in the eyeglasses and image generation equipment.

There is requirement for a cost-effective, optically efficient color sequential illuminator that provides alternating beams of orthogonally polarized illumination light.

There is a further requirement for an image generator that projects alternate orthogonally polarized left and right eye images onto a screen for stereoscopic viewing through a pair of glasses containing a pair of orthogonal polarizing filters.

There is a further requirement for a cost effective, efficient projection screen for displaying said alternating orthogonally polarized left and right eye images wherein the screen incorporates means for capturing a full colour stereoscopic image of the viewer.

There is a further requirement for a cost effective, efficient projection screen for displaying said alternating orthogonally polarized left and right eye images wherein the screen further incorporates means for head and eye tracking.

### SUMMARY OF THE INVENTION

It is a first objective of the invention to provide a cost-effective, optically efficient color sequential illuminator that provides alternating beams of orthogonally polarized illumination light.

It is a second objective of the invention to provide an image generator that projects alternating orthogonally polarized left and right eye images onto a screen for stereoscopic viewing through a pair of glasses containing a pair of orthogonal polarizing filters.

It is a further objective of the invention to provide a cost effective, efficient projection screen for displaying said alternate orthogonally polarized left and right eye images wherein the screen incorporates means for capturing a full colour stereoscopic image of the viewer.

It is a further objective of the invention to provide a cost effective, efficient projection screen for displaying said alternating orthogonally polarized left and right eye images wherein the screen further incorporates means for head and eye tracking.

In one embodiment of the invention there is provided an image generator comprising: first and second light sources emitting light at first and second wavelengths respectively, at first and second angles respectively; a condenser lens; a first SBG operative to diffract said first wavelength light; a second SBG operative to diffract said second wavelength light; a half wave plate; a third SBG identical to said first SBG operative to diffract said first wavelength light; a fourth SBG identical to said second SBG operative to diffract said second wavelength light; a microdisplay; and a projection lens. Each SBG diffracts P-polarised light and transmit S-polarised light when in an active state and transmit P and S polarised light without deviation when in an inactive state. Each of the first and third SBGs is operative to diffract light at said first angle into a common direction towards said microdisplay. Each of the second and fourth SBGs is operative to diffract light at said second angle into the common direction. The image generation device provides left eye perspective image light of the first wavelength at a first polarisation while the first source is on, the second source is off, the first SBG is active and all other SBGs are inactive, and the microdisplay is updated with left eye perspective first wavelength image data. The image generation device provides left eye perspective image light of the first wavelength at a second polarisation while said the first source is on, the second source is off the third SBG is active and all other SBGs are inactive, and the microdisplay is updated with right eye perspective first wavelength image data. The image generation device provides right eye perspective image light of the second wavelength at a first polarisation while the first source is off, the second source is on, the second SBG is active and all other SBGs are inactive, and the microdisplay is updated with left eye perspective second wavelength image data. The image generation device provides right eye perspective image light of the second wavelength at a second polarisation while the first source is off, said the second source is on the fourth SBG is active and all other SBGs are inactive, and the microdisplay is updated with right eye perspective second wavelength image data.

In one embodiment of the invention left eye and right perspective image light is projected onto a screen for viewing by a human operator. Each human operator viewing the screen is equipped with spectacles containing a pair of orthogonal polarizing filters.

In one embodiment of the invention an illumination device according to the principles of the invention comprises: first and second light sources emitting light at first and second wavelengths respectively and at first and second angles respectively; a condenser lens; a first SBG operative to diffract the first wavelength light; a second SBG operative to diffract the second wavelength light; a half wave plate; a third SBG identical to said first SBG operative to diffract the first wavelength light; a fourth SBG identical to the second SBG operative to diffract the second wavelength light; and a quarter wave plate. Each SBG is diffracts P-polarised light and transmits S-polarised light when in an active state and transmit P and S polarised light without deviation when in an inactive state. Each of the first and third SBGs diffracts light at the first angle into a common direction. Each of the second and fourth SBG diffracts light at said second angle into said common direction. The illumination device provides output light of the first wavelength in a first circular polarization sense when the first LED is on, the second LED is off, the first SBG is active and all other SBGs are inactive. The illumination device provides output light of the first wavelength in a second circular polarization sense when the first LED is on, the second LED is off the third SBG is active and all other SBGs are inactive. The illumination device provides output light of the second wavelength in a first circular polarization sense when the first LED is off, the second LED is on, the second SBG is active and all other SBGs are inactive. The illumination device provides output light of the second wavelength in a second circular polarization sense when the first LED is off, the second LED is on the fourth SBG is active and all other SBGs are inactive.

In one embodiment of the invention an illumination device according to the principles of the invention comprises first and second light sources emitting light at first and second wavelengths respectively and at first and second angles respectively; a condenser lens; a first SBG operative to diffract the P-polarized component of the first wavelength light; a second SBG operative to diffract the P-polarized component of the second wavelength light; a third SBG operative to diffract the S-polarized component the first wavelength light; a fourth SBG operative to diffract the P-polarized component of the second wavelength light; and a quarter wave plate. Each SBG is diffracts P-polarised light and transmits S-polarised light when in an active state and transmit P and S polarised light without deviation when in an inactive state. Each of the first and third SBGs diffracts light at the first angle into a common direction. Each of the second and fourth SBG diffracts light at said second angle into said common direction. The illumination device provides output light of the first wavelength in a first circular polarization sense when the first LED is on, the second LED is off, the first SBG is active and all other SBGs are inactive. The illumination device provides output light of the first wavelength in a second circular polarization sense when the first LED is on, the second LED is off the third SBG is active and all other SBGs are inactive. The illumination device provides output light of the second wavelength in a first circular polarization sense when the first LED is off, the second LED is on, the second SBG is active and all other SBGs are inactive. The illumination device provides output light of the second wavelength in a second circular polarization sense when the first LED is off, the second LED is on the fourth SBG is active and all other SBGs are inactive.

In one embodiment of the invention an illumination device comprises: a first light source emitting light at a first wavelength and a first angle; a first SBG operative to diffract the first wavelength light; a second SBG identical to the first SBG diffracts first wavelength light; a quarter wave plate; and a microdisplay. Each SBG diffracts light of a first polarization and transmit light of a second polarisation orthogonal polarization when in an active state and transmit light of any polarization without deviation when in an inactive state. Each SBG diffracts light at the first angle into a common direction. The illumination device provides output light of the first wavelength at a first polarisation when the first light source is on, the first SBG is active and the second SBG is inactive. The illumination device provides output light of the first wavelength at a second polarisation when the first light source is on, the first SBG is inactive and the second SBG is active. The light transmitted in said common direction illuminates the microdisplay. The microdisplay modulates the first polarisation output light with left eye perspective image data and modulates the second polarisation output light with right eye perspective image data.

In one embodiment of the invention an illumination device comprises: a first light source emitting light at a first wavelength and a first angle; a second light source emitting light at said first wavelength and a second angle; a first SBG that diffracts first wavelength light; a second SBG identical to the first SBG that diffracts first wavelength light; a quarter wave plate; and a microdisplay. Each SBG is diffracts light of a first polarization and transmits light of a second orthogonal polarization when in an active state and transmits light of any polarization without deviation when in an inactive state. The light sources are operated pulse sequentially. The first and second SBGs are activated cyclically. The first SBG when in its active state diffracts first polarization light from the first source into an illumination path towards the microdisplay. The second SBG when in its active state diffracts first polarization light from the second source out of the illumination path. The microdisplay modulates the first polarisation output light with left eye perspective image data.

In one embodiment of the invention an SBG group comprising red, green and blue diffracting SBGs is replaced by a single SBG that diffracts red, green and blue light. The incidence angles of the red, green and blue light and the corresponding red, green and blue wavelengths are chosen to satisfy the Bragg condition for a given output direction.

In embodiment of the invention the first SBG device is disposed between the projection lens and the screen.

A display device according to the principles of the invention comprises a image generation module comprising red green and blue emitters, a condenser lens system, a first Switchable Bragg Grating (SBG) device, a relay optical system, a microdisplay, a projection lens system, a beam folding mirror, a holographic screen, a second switchable Bragg grating device, and at least one miniature image sensor further comprising array of photosensitive elements and a miniature objective lens. The screen contains a small aperture for admitting light reflected from the human operator. Light transmitted through the screen aperture is colour sequentially filtered by the second SBG device and imaged by the sensor.

The first SBG device performs the functions of, firstly, converting the source light into sequential red, green and blue collimated illumination and, secondly, providing sequential orthogonally polarized illumination for each colour. By updating the microdisplay with alternative left and right eye perspective images the apparatus provides alternate orthogonally polarized left and right eye images for stereoscopic viewing.

The second switchable grating device comprises a stack of red, green and blue SBGs disposed behind the screen and overlapping the aperture. The second SBG device performs the function of sequentially filtering light from the operator side of the screen.

In one embodiment of the invention the screen is illuminated by colour sequential image from the image generation module at the same time as the camera records sequential colour frames of image light reflected from the human operator. The camera frames and the projected images are sequenced such that at any time the image light recorded by the camera at the image light projected onto the screen have different wavelengths.

In the preferred embodiment of the invention a pair of imaging sensors configured to record left and right eye perspective views is provided.

In one embodiment of the invention the screen is a reflective polarization preserving screen operative to diffract light incident at an oblique angle into a direction substantially normal to the screen surface towards the viewer.

In one embodiment of the invention the mirror is adjustable to accommodate varying viewer eye heights.

In one embodiment of the invention the mirror is equipped with a motorized drive.

In one embodiment of the invention the light sources, condenser lens and first SBG device together provide an illuminator for providing sequential orthogonally polarized illumination light.

In one embodiment of the invention the light sources, condenser lens and first SBG device, relay lens system microdisplay and projection lens together provide an image generator that provides alternate orthogonally polarized left and right eye image light for stereoscopic viewing.

In one embodiment of the invention the light sources, condenser lens and first SBG device, relay lens system microdisplay and projection lens, mirror and screen provide a stereoscopic display device that provides alternate orthogonally polarized left and right eye images for stereoscopic viewing. Said images may be viewed by the operator through a pair of glasses containing a pair of orthogonal polarizing filters. As each filter only passes light which is similarly polarized and blocks the orthogonally polarized light each eye sees only one of the images providing the stereoscopic effect.

In one embodiment of the invention a stack of red, green and blue diffracting SBG filters and at least one image sensor are disposed in proximity to the screen on the opposite side of the screen to the human operator. Each SBG filter is operative to diffractive light out of the field of view of the sensors when in an active state and is operative to transmit light towards the image sensor when in an inactive state. The screen is provided with an aperture to admit light from the human operator's side of the screen.

In one embodiment of the invention there is further providing a means for projecting infrared structured light through a small screen aperture towards said human operator and directing back-scattered light from the human operator into the images sensor via said screen aperture.

In one embodiment of the invention a means for despeckling laser light is disposed between the first SBG device and the microdisplay.

In one embodiment of then invention the mirror is equipped with means for displacing its reflecting surface backwards and forwards at a frequency characterised by a period much shorter than the integration time of the human eye.

In one embodiment of the invention there is further provided means for correcting image distortion.

In one embodiment of the invention the electronic correction means may be further adapted to independently pre-distort the geometry of each primary color represented by the input image data and generate a pre-distorted primary color image data to compensate for differences in the optical refraction of each color, such that when the pre-distorted primary color image associated with the pre-distorted primary color image data is projected through the image projector to the projection screen, the optical and geometric distortions associated with each primary color optical image are eliminated.

In one embodiment of the invention the distortion correction scheme described above may be used to provide edge matching of images projected by two or more display devices.

A more complete understanding of the invention can be obtained by considering the following detailed description in conjunction with the accompanying drawings wherein like index numerals indicate like parts. For purposes of clarity details relating to technical material that is known in the technical fields related to the invention have not been described in detail.

### BRIEF DESCRIPTION OF THE DRAWINGS

FIG. 1 is a schematic side elevation view of an illuminator in one embodiment of the invention.

FIG. 2 is a schematic side elevation view of a first SBG device used in one embodiment of the invention.

FIG. 3A is a schematic side elevation view of an aspect of the operation of a first SBG device used in one embodiment of the invention.

FIG. 3B is a schematic side elevation view of an aspect of the operation of a first SBG device used in one embodiment of the invention.

FIG. 4 is a schematic side elevation view of a first SBG device used in one embodiment of the invention.

FIG. 5A is a schematic side elevation view of an aspect of the operation of a first SBG device used in one embodiment of the invention.

FIG. 5B is a schematic side elevation view of an aspect of the operation of a first SBG device used in one embodiment of the invention.

FIG. 6 is a table illustrating the operational states of the LEDs and first SBG device used in one embodiment of the invention

FIG. 7 is a table illustrating the operational states of the LEDs and first SBG device used in one embodiment of the invention.

FIG. 8 is a schematic side elevation view of a first SBG device used in one embodiment of the invention.

FIG. 9A is a schematic side elevation view of an aspect of the operation of a first SBG device used in one embodiment of the invention.

FIG. 9B is a schematic side elevation view of an aspect of the operation of a first SBG device used in one embodiment of the invention.

FIG. 10 is a schematic side elevation view of a first SBG device used in one embodiment of the invention.

FIG. 11A is a schematic side elevation view of an aspect of the operation of a first SBG device used in one embodiment of the invention.

FIG. 11B is a schematic side elevation view of an aspect of the operation of a first SBG device used in one embodiment of the invention.

FIG. 12 is a schematic front elevation of eyeglasses used with embodiments of the invention providing linearly polarized image light

FIG. 13 is a schematic front elevation of eyeglasses used with embodiments of the invention providing circularly polarized image light.

FIG. 14 is a schematic illustration of an illuminator according to one embodiment of the invention.

FIG. 15A is a schematic illustration of a first operational aspect of an illuminator according to one embodiment of the invention.

FIG. 15B is a schematic illustration of a second operation aspect of an illuminator according to one embodiment of the invention.

FIG. 16 is a schematic illustration of an illuminator according to one embodiment of the invention.

FIG. 17A is a schematic illustration of a first operational aspect of an illuminator according to one embodiment of the invention.

FIG. 17B is a schematic illustration of a second operational aspect of an illuminator according to one embodiment of the invention.

FIG. 18A is a schematic illustration of a first aspect of an illuminator incorporating a light trapping light guide.

FIG. 18B is a schematic illustration of a second aspect of an illuminator incorporating a light trapping light guide.

FIG. 18C is a schematic illustration of a third aspect of an illuminator incorporating a light trapping light guide.

FIG. 19 is a schematic illustration of one embodiment of the invention.

FIG. 20 is a schematic illustration of one embodiment of the invention.

FIG. 21 is a schematic illustration of one embodiment of the invention.

FIG. 22 is a schematic illustration of a diffusing property used in one embodiment of the invention.

FIG. 23 is a schematic illustration of a first operational aspect of an illuminator according to one embodiment of the invention.

FIG. 24 is a schematic illustration of a second operational aspect of an illuminator according to one embodiment of the invention.

FIG. 25 is a schematic illustration of one embodiment of the invention for providing monochromatic illumination from two pulse sequentially operated light sources.

FIG. 26A is a schematic illustration of a first operational aspect of one embodiment of the invention for providing monochromatic illumination from two pulse sequentially operated light sources.

FIG. 26B is a schematic illustration of a second operational aspect of one embodiment of the invention for providing monochromatic illumination from two pulse sequentially operated light sources.

FIG. 27 is a schematic illustration of a display provided in one embodiment of the invention.

FIG. 28A is a schematic illustration of an aspect of the operation of the second SBG device used in one embodiment of the invention.

FIG. 28B is a schematic illustration of an aspect of the operation of the second SBG device used in one embodiment of the invention.

FIG. 28C is a schematic illustration of an aspect of the operation of the second SBG device used in one embodiment of the invention.

FIG. 29 is a schematic side elevation view of a display provided in one embodiment of the invention.

FIG. 30 is a schematic plan view of the embodiment of FIG. 9

FIG. 31 is a schematic plan view of wraparound display based on the embodiment of FIG. 9.

FIG. 32 is a schematic side elevation view of a display provided in one embodiment of the invention that uses an infrared structure lighting projector.

FIG. 33 is a schematic plan view of the embodiment of FIG. 12.

FIG. 34 is a schematic plan view of wraparound display based on the embodiment of FIG. 12.

FIG. 35A is a schematic illustration of an aspect of the operation of the second SBG device used in one embodiment of the invention.

FIG. 35B is a schematic illustration of an aspect of the operation of the second SBG device used in one embodiment of the invention.

FIG. 35C is a schematic illustration of an aspect of the operation of the second SBG device used in one embodiment of the invention.

FIG. 35D is a schematic illustration of an aspect of the operation of the second SBG device used in one embodiment of the invention.

FIG. 36 is a schematic illustration of an embodiment of the invention incorporating a laser beam despeckler.

FIG. 37 is a schematic illustration of another embodiment of the invention incorporating a laser beam despeckler.

FIG. 38 is a schematic illustration of a further embodiment of the invention.

FIG. 39 is a schematic illustration of a further embodiment of the invention.

FIG. 40 is a schematic illustration of a further embodiment of the invention.

FIG. 41 is a schematic illustration of a further embodiment of the invention.

### DETAILED DESCRIPTION OF THE INVENTION

There is requirement for a cost-effective, optically efficient color sequential illuminator that provides alternating beams of orthogonally polarized illumination light.

There is a further requirement for an image generator that projects alternating orthogonally polarized left and right eye images onto a screen for stereoscopic viewing through a pair of glasses containing a pair of orthogonal polarizing filters.

There is a further requirement for a cost effective, efficient projection screen for displaying said alternating orthogonally polarized left and right eye images wherein the screen incorporates means for capturing a full colour stereoscopic image of the viewer.

There is a further requirement for a cost effective, efficient projection screen for displaying said alternating orthogonally polarized left and right eye images wherein the screen further incorporates means for head and eye tracking.

It will be apparent to those skilled in the art that the present invention may be practiced with only some or all aspects of the present invention as disclosed in the following description. For the purposes of explaining the invention well-known features of optical technology known to those skilled in the art of optical design, visual displays, LED and laser technology have been omitted or simplified in order not to obscure the basic principles of the invention.

Unless otherwise stated the term “on-axis” in relation to a ray or beam direction refers to propagation parallel to an axis normal to the surfaces of the optical components described in relation to the embodiments of the invention.

In the following description the terms light, ray, beam and direction will used interchangeably and in association with each other to indicate the propagation of light energy along rectilinear trajectories.

While for the sake of simplicity lenses will be illustrated as single elements configured in an axially symmetric fashion in most applications of the invention the lenses may comprises multi elements systems of refractive lens. In some cases practical embodiments may require mirrors for folding beam paths.

Parts of the following description will be presented using terminology commonly employed by those skilled in the art of optical design.

It should also be noted that in the following description of the invention repeated usage of the phrase “in one embodiment” does not necessarily refer to the same embodiment.

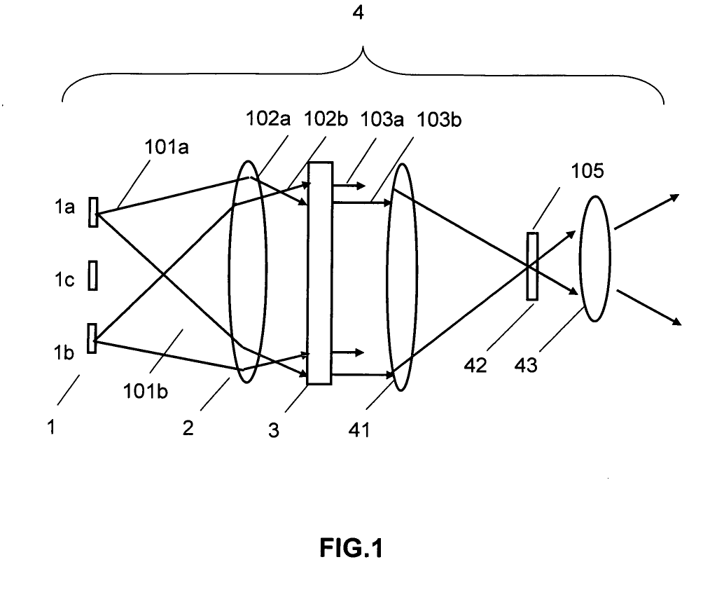

An illumination device according to the principles of the invention is illustrated in the schematic illustration of FIG. 1. The display comprises a light source module generally indicated by 1 comprising the red green and blue emitters 1a,1b,1c, a condenser lens system generally indicated by 2, a first Switchable Bragg Grating (SBG) device 3, a relay optical system generally indicated by 41, a microdisplay panel 42 and a projection lens system generally indicated by 43. The elements 1a, 1b, 1c, 2, 3, 41, 42, 43, which together provided an image projection device are generally indicated by the numeral 4. Advantageously the light source uses LEDs or lasers. LEDs will be assumed in the following description.

The first SBG device is based on transmission Bragg grating technology which, in common with other diffractive technologies, is able to transform complex optical systems into thin, lightweight intrinsically transparent elements. For example, an SBG may encode optical functions such as diffusion and optical power. A SBG is formed by recording a volume phase grating, or hologram, in a polymer dispersed liquid crystal (PDLC) mixture. Typically, SBG devices are fabricated by first placing a thin film of a mixture of photopolymerizable monomers and liquid crystal material between parallel glass plates. Techniques for making and filling glass cells are well known in the liquid crystal display industry. One or both glass plates support electrodes, typically transparent indium tin oxide films, for applying an electric field across the PDLC layer. A volume phase grating is then recorded by illuminating the liquid material with two mutually coherent laser beams, which interfere to form the desired grating structure. During the recording process, the monomers polymerize and the HPDLC mixture undergoes a phase separation, creating regions densely populated by liquid crystal micro-droplets, interspersed with regions of clear polymer. The alternating liquid crystal-rich and liquid crystal-depleted regions form the fringe planes of the grating. The resulting volume phase grating can exhibit very high diffraction efficiency, which may be controlled by the magnitude of the electric field applied across the PDLC layer. When an electric field is applied to the hologram via transparent electrodes, the natural orientation of the LC droplets is changed causing the refractive index modulation of the fringes to reduce and the hologram diffraction efficiency to drop to very low levels. Note that the diffraction efficiency of the device can be adjusted, by means of the applied voltage, over a continuous range from near 100% efficiency with no voltage applied to essentially zero efficiency with a sufficiently high voltage applied. U.S. Pat. No. 5,942,157 and U.S. Pat. No. 5,751,452 describe monomer and liquid crystal material combinations suitable for fabricating SBG devices.

The first SBG device shown in FIG. 1 performs two functions. Firstly, it converts the LED output light into sequential red, green and blue collimated illumination. Secondly, it provides sequential orthogonally polarized illumination for each colour. By updating the microdisplay 42 with alternative left and right eye perspective images the apparatus provides alternate orthogonally polarized left and right eye images for stereoscopic viewing as will be discussed below.

The LEDs provide divergent light which is collimated by the condenser lens 2. For example the LEDs 1a,1b provide the divergent beams 101a,101b, which are collimated to provide the off-axis collimated beams 102a,102b. The SBG device 3 diffracts the beams 102a,102b sequentially into an on axis direction providing the illumination beams 103a,103b. The relay lens 41 focuses the beams onto the surface of a microdisplay 42. The microdisplay image is then imaged onto a screen (which is not illustrated in FIG. 1) by means of the projection lens 43.

It will be clear from consideration of FIG. 1 that the apparatus illustrated therein provides an illuminator, an image generator and a complete stereoscopic image display. The elements 1,2,3 of FIG. 1 together provide an illuminator for providing sequential orthogonally polarized illumination light. The elements 1, 2, 3, 41, 42, 43 together provide an image generator that provides alternate orthogonally polarized left and right eye image light for stereoscopic viewing. The left and right eye images are projected alternately onto a screen where they may be viewed through a pair of glasses containing a pair of orthogonal polarizing filters. As each filter only passes light which is similarly polarized and blocks the orthogonally polarized light each eye sees only one of the images providing the stereoscopic effect.

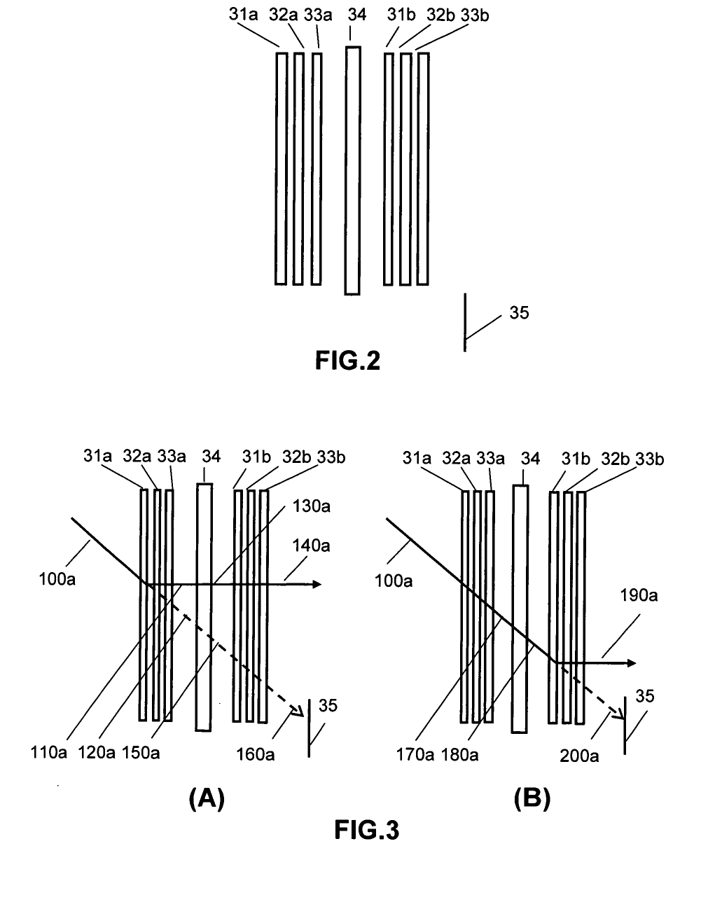

The operation of the first SBG device, is now discussed in more detail in the following paragraphs with reference to FIGS. 2-5.

The first switchable grating device 3 is configured as a stack of separately switchable SBG layers. Said optical elements are aligned along an optical axis normal to the surface of each element Each SBG layer is recorded in HPDLC sandwiched between transparent substrates to which transparent conductive coatings have been applied. Each SBG has a diffracting state and a non-diffracting state. Each SBG diffracts light in a direction substantially parallel to the optical axis when in said active state. However, each SBG is substantially transparent to said light when in said inactive state. Each SBG is operative to diffract at least one wavelength of red, green or blue light.

Referring to schematic side elevation view FIG. 2 we see that the first SBG device comprises first and second SBG groups 31a,32a,33a and 31b,32b,33b separated by a half wave plate (HWP) 35. Said first and second SBG groups have substantially identical specifications. One of the well-known attributes of transmission SBG is that the liquid crystal molecules tend to align normal to the grating fringe planes. The effect of the liquid crystal molecule alignment is that SBG transmission gratings efficiently diffract P polarized light (ie light with the polarization vector in the plane of incidence) but have nearly zero diffraction efficiency for S polarized light (ie light with the polarization vector normal to the plane of incidence.

Turning now to FIG. 3 we consider the propagation of light from LED 1a through the SBG device of FIG. 2. The LED light, which is assumed to be collimated and randomly polarized, is indicated by 100a. The LEDs 1b,1c are assumed to be switched off. We first consider the generation of S polarized light which is illustrated in FIG. 3A. In this state the SBG 31a is activated and all other SBGs are deactivated. The SBG element 31a diffracts the P-polarized component of incident light 100a into a direction parallel to the optical axis as the light 110a. The incident S-polarized light that is not diffracted continues to propagate away from the optical axis in the directions 120a. The half wave plate rotates the polarization of incident light through ninety degrees thereby converting S-polarized light to P-polarized light and vice versa. After propagation through the HWP said diffracted P-polarized light 110a is converted to S-polarized light 130a. After propagation through the second SBG group it emerges as the S-polarized light 140a. However, said incident S-polarized light that was not diffracted by the first SBG group 120a is converted to P-polarized light 150a and proceeds through the second SBG group without deviation emerging as the light 160a which is captured by light absorbing stop 35.

FIG. 3B illustrates the generation of P-polarized output light. In this state the SBG 31a is deactivated, SBG 31b is activated and all other SBGs remain deactivated. Again, collimated incident light is indicated by 100a. The light 100 propagates through the first SBG group without deviation to provide the unpolarized 170a and passes the through the HWP to provide the unpolarized light 180a. The activated SBG element 31b now diffracts the P-polarized component of light 180a into a direction parallel to the optical axis as the light 190a. The incident S-polarized component of light 180a, which is not diffracted, continues to propagate away from the optical axis in the directions 200a before being captured by light absorbing stop 35. The process illustrated in FIG. 3 is repeated for LEDs 1b and 1c.

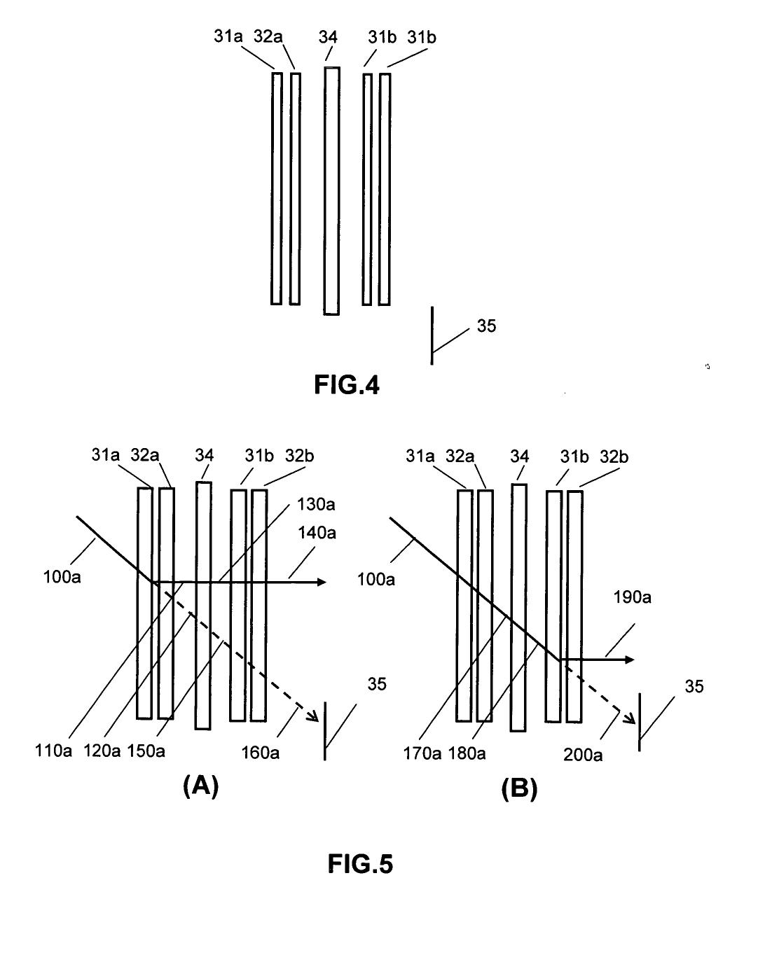

In one embodiment of the invention the first SBG device may be configured for two colour switching. As illustrated in FIG. 4 this embodiment is identical to the one of FIG. 2 with the layers 33a,33b being removed. In the embodiment of FIG. 4 the LEDs 1a,1b would, advantageously, provide red and cyan illumination. The illumination from such an embodiment could be used to illuminate a stereoscopic display based on the well known principle of the red/cyan anaglyph. The operation of the SBG device of FIG. 4 is illustrated in FIG. 5 which is identical to FIG. 5 except that the layers 33a,33b have been removed.

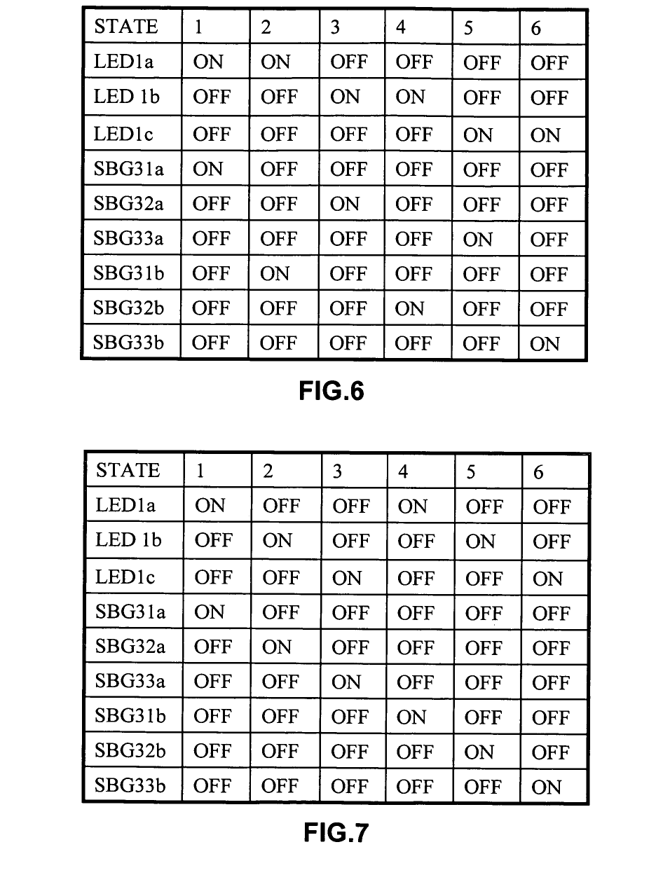

The sequence of LED and SBG states illustrated in FIG. 3 is summarized in the table of FIG. 6. Essentially the process provides red green and blue illumination in sequence with S and P polarization light being provided in sequence for each said colour.

It will be apparent from the above discussion that in an alternative embodiment of the invention the illumination process may be based on other LED and SBG switching schemes. For example, referring to the table of FIG. 7 an alternative switching scheme provides first P polarized light and secondly S polarized with the LEDs being switched sequential through red green and blue for each polarization state.

It will be clear from consideration of the FIGS. 2-5 that the mechanism illustrated in the Figures for trapping non diffracted light represents one possible solution only. It will be clear to those skilled in the art of optical design that other methods may be used depending on the space, cost and other constraints of the application concerned. The invention does not rely on any particular method of trapping non-diffracted light.

It will also be apparent to those skilled in the art that alternative methods of configuring LEDs of different wavelengths and SBG may be used to practice the invention. For example the LEDs used in the present invention may be configured according to the principles and methods disclosed in U.S. Pat. No. 6,115,152 Issued 5 Sep. 2000 entitled HOLOGRAPHIC ILLUMINATION SYSTEM and PCT application: PCT/US2006/041689 entitled Compact HOLOGRAPHIC ILLUMINATION DEVICE filed on 27 Oct. 2006, both of which are incorporated by reference in their entireties herein. For example, in an alternative embodiment of the invention, which is also illustrated by FIG. 4, one SBG in each group may contain two superimposed Bragg gratings operative to diffract different wavelengths. The SBGs 31a and 31b may be operative to diffract red and green light while the SBGs 32a,32b diffract blue light only. Such a configuration may allow more flexibility in the choice of incident angles. The basic principles of recording multiple superimposed gratings will be well known to those skilled in the art of holography. However, superimposed Bragg gratings tend to suffer from reduced diffraction efficiency. In another embodiment of the invention multiple LEDs of a particular wavelength may be used to increase the light output of the illuminator. The present invention may use the methods for combining multiple LEDs disclosed in U.S. Pat. No. 6,115,152.

In one embodiment of the invention a method of providing an illuminator that provides alternate S and P polarized colour sequential illumination light based on the principles of the embodiment of FIG. 3 comprises the following steps:
a) Providing an SBG device comprising in sequence a first stack of red, green and blue diffracting SBGs 31a,32a,33a; a half wave plate, 34; and a second stack of red, green and blue diffracting SBGs 31b,32b,33b;
b) Providing an LED module comprising LEDs 1a,1b,1c emitting light 100a,100b,100c respectively;
c) Switching LED 1a on to provide first wavelength unpolarized light 100a and switching LEDs 1b,1c off;
d) Activating SBG 31a and deactivating all other SBGs;
e) Diffracting light 100a at SBG 31a to provide P-polarized diffracted light 110a and non to diffracted S-polarized light 120a;
f) Converting P-polarized light 110a into S-polarized light 130a by means of HWP 33
g) Converting S-polarized light 120a into P-polarized light 150a by means of HWP 33
h) Providing S-polarized first wavelength output light 140a after light 130a has propagated without deviation through SBGs 31b,32b;
i) Providing P-polarized first wavelength output light 160a after light 150a has propagated without deviation through SBGs 31b,32b;
j) Trapping light 160a;
k) Deactivating SBG 31a and activating SBG 31b with all other SBGs remaining deactivated;
l) Transmitting unpolarized light 100a without deviation through SBGs 31a,32a to provide unpolarized light 170a
m) Transmitting unpolarized light 170a through HWP 33 to provide unpolarized light 180a
n) Diffracting light 180a at SBG 31b to provide P-polarized diffracted light 190a and non diffracted S-polarized light 200a;
o) Trapping light 200a;
p) Repeating steps a-m for illumination from LEDs 100b,100c in turn.

In one embodiment of the invention there is provided a method of providing alternate S and P polarized colour sequential image light based on the principles of the embodiment of FIG. 3 comprises the following steps:
a) Providing an SBG device comprising in sequence a first stack of red, green and blue diffracting SBGs 31a,32a,33a; a half wave plate, 34; and a second stack of red, green and blue diffracting SBGs 31b,32b,33b;
b) Providing an LED module comprising LEDs 1a, 1b, 1c emitting light 100a,100b,100c respectively;
c) Providing a microdisplay;
d) Providing a projection lens;
e) Providing a screen;
f) Switching LED 1a on to provide first wavelength unpolarized light 100a and switching LEDs 100b,100c off;
g) Updating the microdisplay with left eye image information at said first wavelength
h) Activating SBG 31a and deactivating all other SBGs;
i) Diffracting light 100a at SBG 31a to provide P-polarized diffracted light 110a and non diffracted S-polarized light 120a;
j) Converting P-polarized light 110a into S-polarized light 130a by means of HWP 33
k) Converting S-polarized light 120a into P-polarized light 150a by means of HWP 33
l) Providing S-polarized first wavelength output light 140a after light 130a has propagated without deviation through SBGs 31b,32b;
m) Illuminating said microdisplay with said S-polarized output light 140a;
n) Projecting the left eye image displayed on said microdisplay onto said screen using said projection lens;
o) Providing P-polarized first wavelength output light 160a after light 150a has propagated without deviation through SBGs 31b,32b;
p) Trapping light 160a;
q) Updating the microdisplay with right eye image information at said first wavelength;
r) Deactivating SBG 31a and activating SBG 31b with all other SBGs remaining deactivated;
s) Transmitting unpolarized light 100a without deviation through SBGs 31a,32a to provide unpolarized light 170a
t) Transmitting unpolarized light 170a through HWP 33 to provide unpolarized light 180a
u) Diffracting light 180a at SBG 31b to provide P-polarized diffracted light 190a and non diffracted S-polarized light 200a;
v) Illuminating said microdisplay with said P-polarized output light 190a;
w) Projecting the right eye image information displayed on said microdisplay onto said screen using said projection lens;
x) Trapping light 200a;
y) Repeating steps a-m for illumination from LEDs 100b, 100c in turn.

The left and right eye information displayed on the microdisplay may comprise computer generated images.

In one embodiment of the invention the colour sequential image generator is used in conjunction with a pair of eyeglasses equipped with orthogonal polarizers for the left and right eye to provide a stereoscopic effect The output S and P polarized is projected onto a screen such as the screen 6 illustrated in FIG. 1. The apparatus illustrated in FIG. 3 may be used. The screen should ideally be fabricated from a polarization-maintaining material. The viewer wears eyeglasses which contain a pair of orthogonal polarizing filters. As each filter only passes light which is similarly polarized and blocks the orthogonally polarized light, each eye only sees one of the images.

The steps of activating the SBGs and update the microdisplay with left or right eye information are ideally performed simultaneously. However, since the duty cycles of SBGs and microdisplays will differ there will inevitably be a small lag.

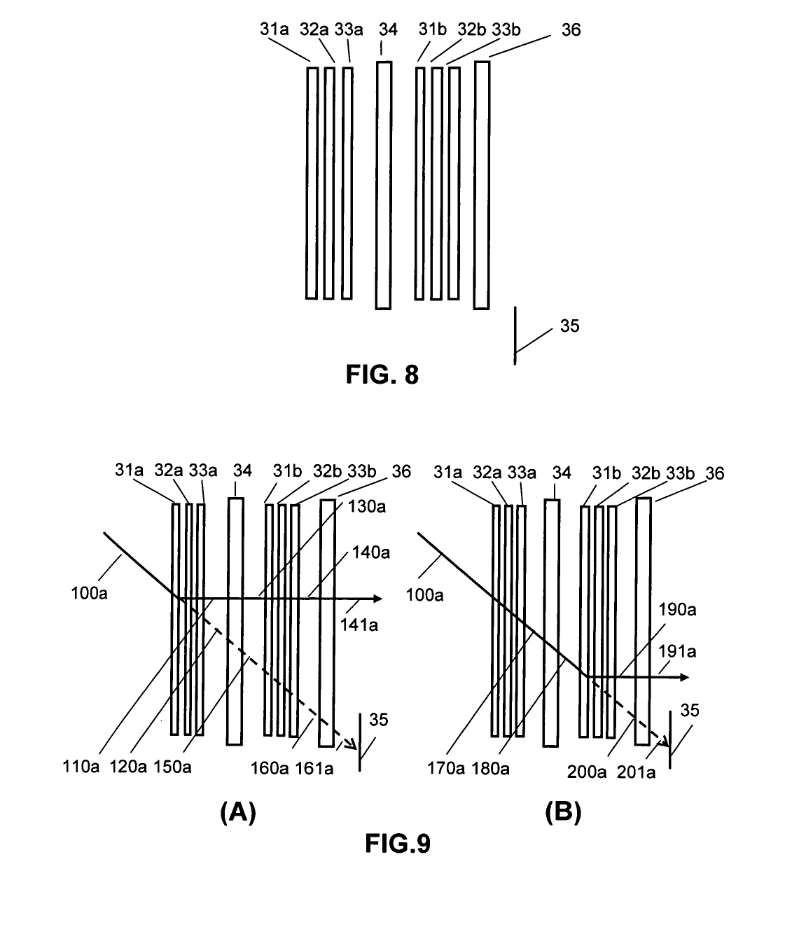

Linearly polarized glasses suffer from the problem that the viewer's head must be kept level to avoid tilting of the viewing filters causing left and right images images to bleed over to the opposite channel. In one embodiment of the of the invention the first SBG device described above and illustrated in FIGS. 2-5 may be configured to provide circularly polarized light instead of linearly polarized light. In such an embodiment of the invention the first SBG device as illustrated in FIG. 8 and FIG. 9 comprises the apparatus of FIG. 2 and FIG. 4 respectively but in each case further comprises a quarter wave plate (QWP) 36. The effect of the QWP is to convert S-polarized light into circularly polarized light of a first sense and to convert P-polarized light into circularly polarized light of a second sense.

FIGS. 9A-9B illustrate the use of the apparatus of FIG. 8 to provide different colour sequential illumination with first and second sense circularly polarized light being provided in sequence for each said colour. FIG. 9A illustrates the generation of circularly polarized light of a first sense. The LED light, which is assumed to be collimated and randomly polarized, is indicated by 100a. The LEDs 1b,1c are assumed to be switched off. We first consider the generation of circularly polarized light of a first sense which is illustrated in FIG. 9A. In this state the SBG 31a is activated and all other SBGs are deactivated. The SBG element 31a diffracts the P-polarized component of incident light 100a into a direction parallel to the optical axis as the light 110a. The incident S-polarized light that is not diffracted continues to propagate away from the optical axis in the directions 120a. The half wave plate rotates the polarization of incident light through ninety degrees thereby converting S-polarized light to P-polarized light and vice versa. After propagation through the HWP said diffracted P-polarized light 110a is converted to S-polarized light 130a. After propagation through the second SBG group it emerges as the S-polarized light 140a. The QWP converts the light 140a into circularly polarized light of a first sense 141a. The incident S-polarized light that was not diffracted by the first SBG group 120a is converted to P-polarized light 150a and proceeds through the second SBG group without deviation emerging as the light 160a which is converted into circularly polarized light of a second sense 161a before being captured by light absorbing stop 35.

FIG. 9B illustrates the generation of circularly polarized light of a second sense. In this state the SBG 31a is deactivated, SBG 31b is activated and all other SBGs remain deactivated. Again, collimated incident light is indicated by 100a. The light 100 propagates through the first SBG group without deviation to provide the unpolarized 170a and passes the through the HWP to provide the unpolarized light 180a. The activated SBG element 31b now diffracts the P-polarized component of light 180a into a direction parallel to the optical axis as the light 190a. The QWP converts the light 190a into circularly polarized light of a second sense 191a. The incident S-polarized component of light 180a, which is not diffracted, continues to propagate away from the optical axis in the directions 200a and is converted to circularly polarized light of a first sense 201 before being captured by light absorbing stop 35. The process illustrated in FIG. 9 is repeated for LEDs 1b and 1c.

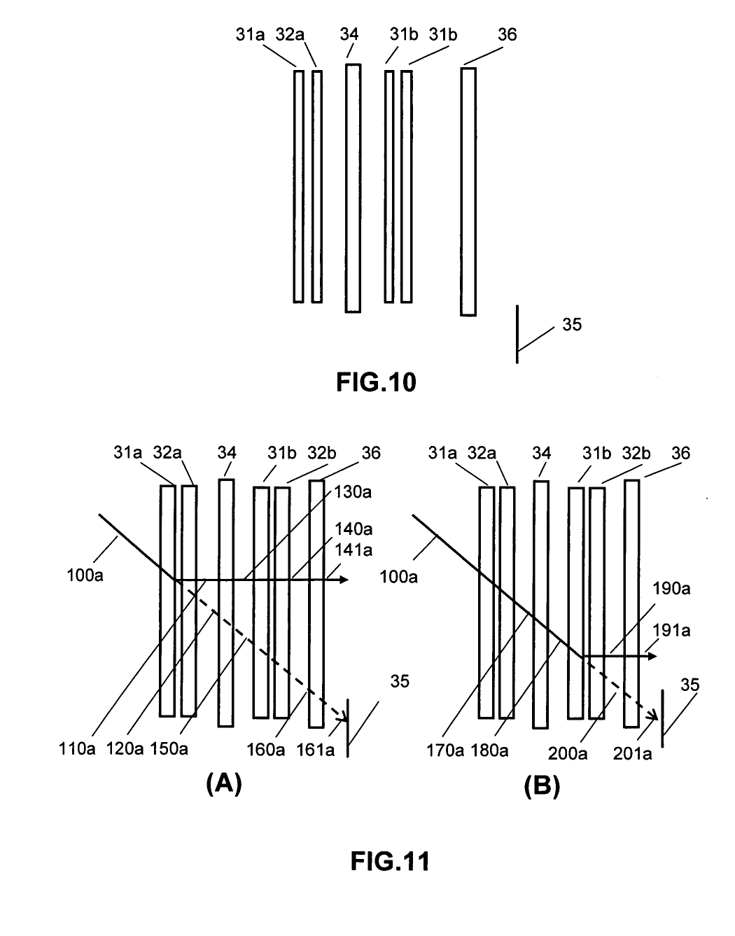

In one embodiment of the invention the first SBG device may be configured for two colour switching. As illustrated in FIG. 10 this embodiment is identical to the one of FIG. 8 with the layers 33a,33b being removed. The operation of the SBG device of FIG. 10 is illustrated in FIG. 11 which is identical to FIG. 9 except that the layers 33a,33b have been removed.

The sequence of LED and SBG states illustrated in FIG. 9 is described by the table of FIG. 6. Essentially, the process provides red green and blue illumination in sequence with first and second sense circularly polarized light being provided in sequence for each said colour.

It should be noted that the first and second circular polarization senses are commonly referred to as right hand or left hand circular polarizations.

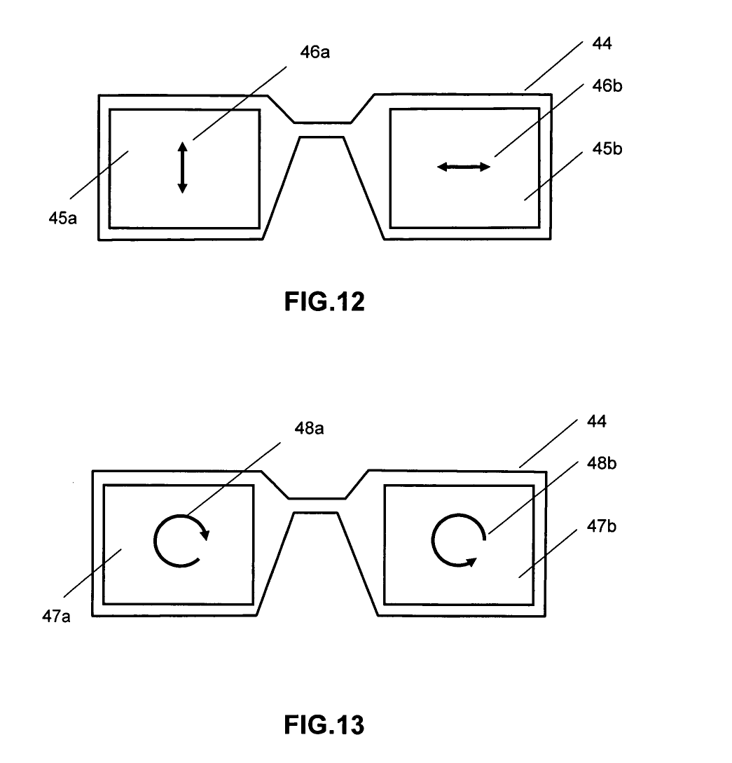

FIGS. 12-13 are schematic front elevation views of eye glasses used to view the projected images providing by the above-described 3D projection schemes.

The eyeglasses illustrated in FIG. 12 may be used to view the circularly polarized projected image light provided using the apparatus of FIG. 2 and FIG. 4. The eyeglasses comprise a frame 44, left and right eyepieces 45,45b, having orthogonal polarizing characteristics indicated by 46a,46b

The eyeglasses illustrated in FIG. 13 may be used to view the circularly polarized projected image light provided using the apparatus of FIG. 8 and FIG. 10. The eyeglasses comprise a frame 44, left and right eyepieces 47,47b, having opposing circular polarizing characteristics indicated by 48a,48b.

In one embodiment of the invention a method of providing an illuminator that provides alternate S and P polarized colour sequential illumination light based on the principles of the embodiment of FIG. 3 comprises the following steps:
a) Providing an SBG device comprising in sequence a first stack of red, green and blue diffracting SBGs 31a,32a,33a; a half wave plate, 34; and a second stack of red, green and blue diffracting SBGs 31b,32b,33b;
b) Providing an LED module comprising LEDs 1a,1b,1c emitting light 100a,100b,100c respectively;
c) Switching LED 1a on to provide first wavelength unpolarized light 100a and switching LEDs 1b,1c off;
d) Activating SBG 31a and deactivating all other SBGs;
e) Diffracting light 100a at SBG 31a to provide P-polarized diffracted light 110a and non diffracted S-polarized light 120a;
f) Converting P-polarized light 110a into S-polarized light 130a by means of HWP 33
g) Converting S-polarized light 120a into P-polarized light 150a by means of HWP 33
h) Providing S-polarized first wavelength output light 140a after light 130a has propagated without deviation through SBGs 31b,32b;
i) Providing P-polarized first wavelength output light 160a after light 150a has propagated without deviation through SBGs 31b,32b;
j) Trapping light 160a;
k) Deactivating SBG 31a and activating SBG 31b with all other SBGs remaining deactivated;
l) Transmitting unpolarized light 100a without deviation through SBGs 31a,32a to provide unpolarized light 170a
m) Transmitting unpolarized light 170a through HWP 33 to provide unpolarized light 180a
n) Diffracting light 180a at SBG 31b to provide P-polarized diffracted light 190a and non diffracted S-polarized light 200a;
o) Trapping light 200a;
p) Repeating steps c)-p) for illumination from LEDs 100b, 100c in turn with the SBG pairs 32a,32b and 33a,33b respectively performing the switching functions of the SBGs 31a,31b in steps d) and k).

In one embodiment of the invention there is provided a method of providing alternate S and P polarized colour sequential image light based on the principles of the embodiment of FIG. 3 comprises the following steps:
a) Providing an SBG device comprising in sequence a first stack of red, green and blue diffracting SBGs 31a,32a,33a; a half wave plate, 34; and a second stack of red, green and blue diffracting SBGs 31b,32b,33b;
b) Providing an LED module comprising LEDs 1a,1b,1c emitting light 100a,100b,100c respectively;
c) Providing a microdisplay;
d) Providing a projection lens;
e) Providing a screen;
f) Switching LED 1a on to provide first wavelength unpolarized light 100a and switching LEDs 100b,100c off;
g) Updating the microdisplay with left eye image information at said first wavelength
h) Activating SBG 31a and deactivating all other SBGs;
i) Diffracting light 100a at SBG 31a to provide P-polarized diffracted light 110a and non diffracted S-polarized light 120a;
j) Converting P-polarized light 110a into S-polarized light 130a by means of HWP 33
k) Converting S-polarized light 120a into P-polarized light 150a by means of HWP 33
l) Providing S-polarized first wavelength output light 140a after light 130a has propagated without deviation through SBGs 31b,32b;
m) Converting S-polarized light 140a into first sense circularly polarized light 141a;
n) Illuminating said microdisplay with said circularly-polarized light 141a;
o) Projecting the left eye image displayed on said microdisplay onto said screen using said projection lens;
p) Providing P-polarized first wavelength output light 160a after light 150a has propagated without deviation through SBGs 31b,32b;
q) Trapping light 160a;
r) Updating the microdisplay with right eye image information at said first wavelength;
s) Deactivating SBG 31a and activating SBG 31b with all other SBGs remaining deactivated;
t) Transmitting unpolarized light 100a without deviation through SBGs 31a,32a to provide unpolarized light 170a
u) Transmitting unpolarized light 170a through HWP 33 to provide unpolarized light 180a
v) Diffracting light 180a at SBG 31b to provide P-polarized diffracted light 190a and non diffracted S-polarized light 200a;
w) Converting P-polarized light 190a into second sense circularly polarized light 191a;
x) Illuminating said microdisplay with said circularly-polarized light 191a;
y) Projecting the right eye image information displayed on said microdisplay onto said screen using said projection lens;
z) Trapping light 200a;
aa) Repeating steps a)-aa) for illumination from LEDs 100b, 100c in turn with the SBG pairs 32a,32b and 33a,33b respectively performing the switching functions of the SBGs 31a,31b in steps h) and s).

The projected image is viewed through a pair of eye glasses which also contain a pair of circular polarizing filters. As each filter only passes light which is similarly circularly polarized and blocks light circularly polarised in an opposing sense, each eye only sees one of the left or right eye images. The screen should ideally be fabricated from a polarization maintaining material.

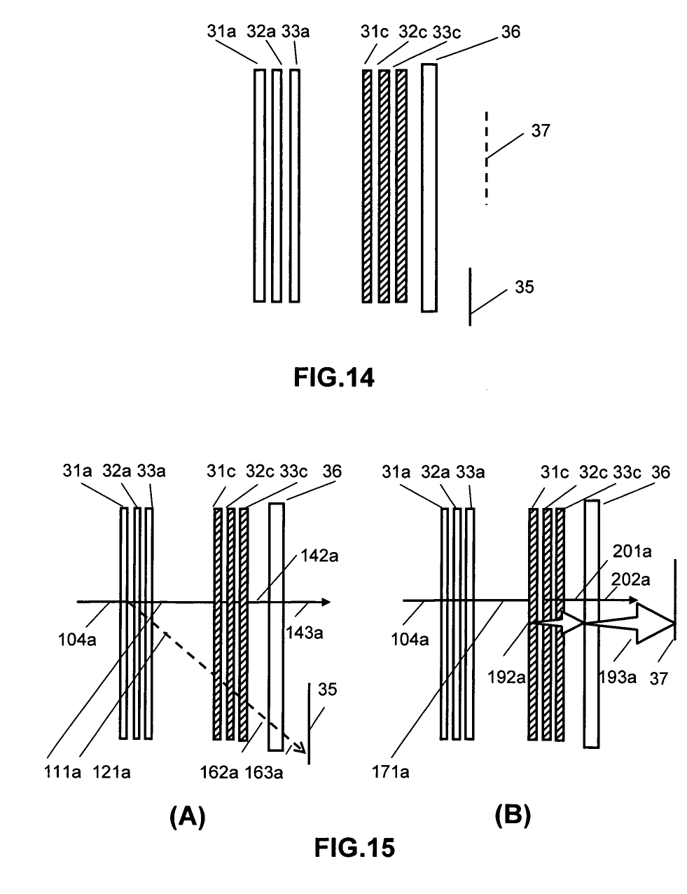

In one embodiment of the invention the need for a HWP in the first SBG device is eliminated by using one group of SBGs designed to diffract P-polarized light and second group of SBGs design to diffract S-polarized light. The basic principles of such an embodiment are illustrated in the schematic side elevation views of FIGS. 14-15. The apparatus of FIGS. 14-15 is similar to that of FIGS. 8-9 with the difference that SBGs 31b,32b,32b which diffract P-polarized light are replaced by the SBGs 31c,32c,32c which diffract S-polarized light. The apparatus of FIG. 14 also includes a second light stop indicated by 37. It will be appreciated from the above discussion of the properties of switchable Bragg gratings that an SBG for diffracting S-polarized light can be provided by rotating an SBG for diffracting P-polarized light through ninety degrees around its optical axis.

FIGS. 15A-15B illustrate the use of the apparatus of FIG. 14 to provide different colour sequential illumination with first and second sense circularly polarized light being provided in sequence for each said colour.

FIG. 15A illustrates the generation of circularly polarized light of a first sense. The LED light, which is assumed to be collimated and randomly polarized, is indicated by 104a. The LEDs 1b,1c are assumed to be switched off. We first consider the generation of circularly polarized light of a first sense which is illustrated in FIG. 15A. In this state the SBG 31a is activated and all other SBGs are deactivated. The SBG element 31a diffracts the P-polarized component of incident light 104a into the off axis direction 121a. The incident S-polarized light that is not diffracted continues to propagate parallel to the optical axis in the direction 111a. After propagation through the second SBG group it emerges as the S-polarized light 142a. The QWP converts the light 142a into circularly polarized light of a first sense 143a. The diffracted P-polarized light 121a proceeds through the second SBG group without deviation emerging as the light 162a which is converted into circularly polarized light of a second sense 163a before being captured by light absorbing stop 35.

FIG. 15B illustrates the generation of circularly polarized light of a second sense. In this state the SBG 31a is deactivated, SBG 31c is activated and all other SBGs remain deactivated. Again, collimated incident light is indicated by 104. The light 104 propagates through the first SBG group without deviation to provide the unpolarized light 171a. The activated SBG element 31c now diffracts the S-polarized component of light 171a into a direction out of the plane of the Figure as the light 192. The QWP converts the light 192 into circularly polarized light of a second sense 193 which is captured by a light stop 37. The incident P-polarized component of light 171a, which is not diffracted, continues to propagate along the optical axis in the directions 201a and is converted to circularly polarized light of a first sense 202a before being captured by the second light absorbing stop 37. The process illustrated in FIG. 15 is repeated for LEDs 1b and 1c.

It will be clear from consideration of the embodiment of FIGS. 14-15 that either the diffracted or non-diffracted S or P polarized light may be used to illuminate the microdisplay.

In one embodiment of the invention based on the embodiment of FIGS. 14-15 the first SBG device may be configured for two colour switching. This embodiment is identical to the one of FIG. 14-15 with the layers 33a, 33b being removed.

In one embodiment of the invention a method of providing an illuminator that provides alternate S and P polarized colour sequential illumination light based on the principles of the embodiment of FIG. 3 comprises the following steps:
a) Providing an SBG device comprising in sequence a first stack of red, green and blue diffracting SBGs 31a,32a,33a; a second stack of red, green and blue diffracting SBGs 31c,32c,33c and a circular polarizer 36;
b) Providing an LED module comprising LEDs 1a,1b,1c emitting light 104a,104b,104c respectively;
c) Switching LED 1a on to provide first wavelength unpolarized light 104a and switching LEDs 1b,1c off;
d) Activating SBG 31a and deactivating all other SBGs;
e) Diffracting light 104a at SBG 31a to provide P-polarized diffracted light 121a and non diffracted S-polarized light 111a;
f) Providing S-polarized first wavelength light 142a after light 111a has propagated without deviation through SBGs 31c,32c,33c;
g) Providing P-polarized first wavelength light 162a after light 121a has propagated without deviation through SBGs 31c,32c,33c;
h) Converting S-polarized light 142a into circularly polarized light 143a;
i) Converting P-polarized light 162a into circularly polarized light 163a;
j) Trapping light 163a;
k) Deactivating SBG 31a and activating SBG 31b with all other SBGs remaining deactivated;
l) Transmitting unpolarized light 104a without deviation through SBGs 31a,32a to provide unpolarized light 171a
m) Diffracting light 171a at SBG 31b to provide S-polarized diffracted light 192a and non diffracted P-polarized light 201a;
n) Converting P-polarized light 201a into circularly polarized light 202a;
o) Converting S-polarized light 192a into circularly polarized light 193a;
p) Trapping light 193a;
q) Repeating steps c)-p) for illumination from LEDs 100b, 100c in turn with the SBG pairs 32a,32c and 33a,33c respectively performing the switching functions of the SBGs 31a,31c.

In one embodiment of the invention there is provided a method of providing alternate S and P polarized colour sequential image light based on the principles of the embodiment of FIG. 3 comprises the following steps:
a) Providing an SBG device comprising in sequence a first stack of red, green and blue diffracting SBGs 31a,32a,33a; a second stack of red, green and blue diffracting SBGs 31c,32c,33c and a circular polarizer 36;
b) Providing an LED module comprising LEDs 1a,1b,1c emitting light 104a,104b,104c respectively;
c) Providing a microdisplay;
d) Providing a projection lens;
e) Providing a screen;
f) Switching LED 1a on to provide first wavelength unpolarized light 104a and switching LEDs 1b,1c off;
g) Updating the microdisplay with left eye image information at said first wavelength;
h) Activating SBG 31a and deactivating all other SBGs;
i) Diffracting light 104a at SBG 31a to provide P-polarized diffracted light 121a and non diffracted S-polarized light 111a;
j) Providing S-polarized first wavelength light 142a after light 111a has propagated without deviation through SBGs 31c,32c,33c;
k) Providing P-polarized first wavelength light 162a after light 121a has propagated without deviation through SBGs 31c,32c,33c;
l) Converting S-polarized light 142a into circularly polarized light 143a;
m) Converting P-polarized light 162a into circularly polarized light 163a;
n) Trapping light 163a;
o) Illuminating said microdisplay with said circularly-polarized light 143a;
p) Projecting the left eye image displayed on said microdisplay onto said screen using said projection lens;
q) Deactivating SBG 31a and activating SBG 31b with all other SBGs remaining deactivated;
r) Transmitting unpolarized light 104a without deviation through SBGs 31a,32a to provide unpolarized light 171a
s) Diffracting light 171a at SBG 31b to provide S-polarized diffracted light 192a and non diffracted P-polarized light 201a;
t) Converting P-polarized light 201a into circularly polarized light 202a;
u) Converting S-polarized light 192a into circularly polarized light 193a;
v) Trapping light 193a;
w) Illuminating said microdisplay with said circularly-polarized light 202a;
x) Projecting the right eye image information displayed on said microdisplay onto said screen using said projection lens;
y) Repeating steps f)-x) for illumination from LEDs 100b, 100c in turn with the SBG pairs 32a,32c and 33a,33c respectively performing the switching functions of the SBGs 31a,31c.

The projected image is viewed through a pair of eye glasses which also contain a pair of circular polarizing filters. As each filter only passes light which is similarly circularly polarized and blocks light circularly polarised in an opposing sense, each eye only sees one of the left or right eye images. The screen should ideally be fabricated from a polarization maintaining material.

It will be clear from consideration of the embodiment of FIGS. 14-15 that the stops indicated by 35 and 37 may be configured in many different ways depending on the output directions 193a and 163a of the diffracted S and P light paths.

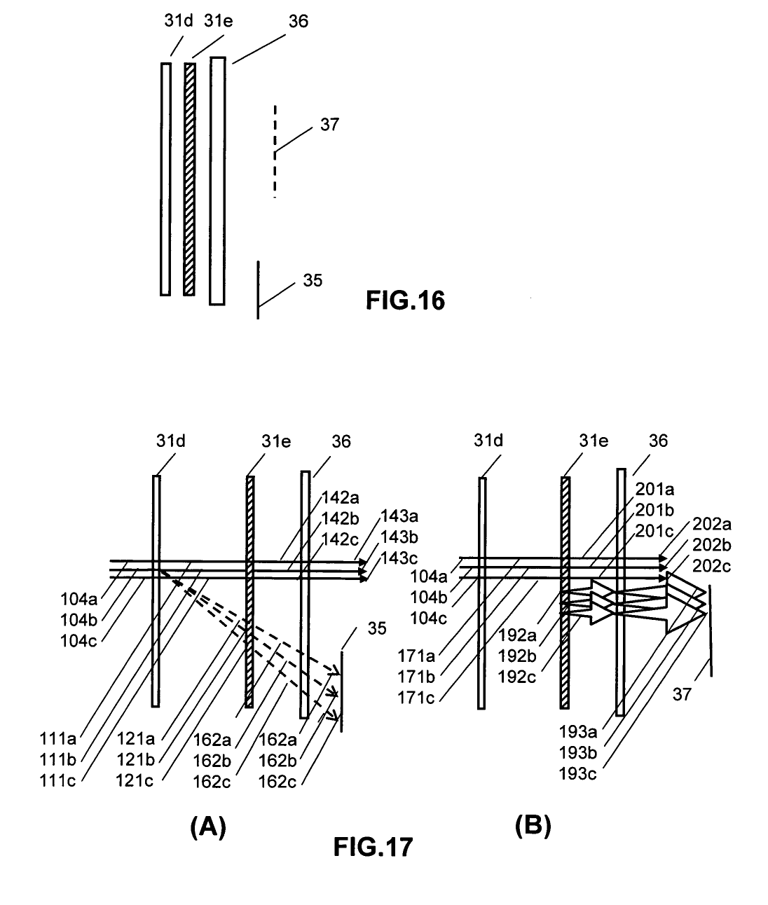

In further embodiments of the invention an SBG group comprising red, green and blue diffracting SBGs as illustrated in FIGS. 2, 8 and 14 may be replaced by a single SBG that diffracts red, green and blue light. The incidence angles of the red, green and blue light and the corresponding red, green and blue wavelengths are chosen to satisfy the Bragg condition for a given output direction. This principle is applied in one embodiment of the invention illustrated in FIGS. 16-17. The embodiment of FIGS. 16-17 is related to the embodiment shown in FIGS. 14-15. However, the functions of SBGs 31a,32a,33a are performed by a single SBG 31d, and the functions of SBGs 31c,32c,33c are performed by a single SBG 31e.

FIG. 17A illustrates the generation of circularly polarized light of a first sense. The LED light, which is assumed to be collimated and randomly polarized, is indicated by 104a. The LEDs 1b,1c are assumed to be switched off. We first consider the generation of circularly polarized light of a first sense which is illustrated in FIG. 15A. In this state the SBG 31a is activated and all other SBGs are deactivated. The SBG element 31a diffracts the P-polarized component of incident light 104a into the off axis direction 121a. The incident S-polarized light that is not diffracted continues to propagate parallel to the optical axis in the direction 111a. After propagation through the second SBG group it emerges as the S-polarized light 142a. The QWP converts the light 142a into circularly polarized light of a first sense 143a. The diffracted P-polarized light 121a proceeds through the second SBG group without deviation emerging as the light 162a which is converted into circularly polarized light of a second sense 163a before being captured by light absorbing stop 35.

FIG. 17B illustrates the generation of circularly polarized light of a second sense. In this state the SBG 31a is deactivated, SBG 31c is activated and all other SBGs remain deactivated. Again, collimated incident light is indicated by 104. The light 104 propagates through the first SBG group without deviation to provide the unpolarized light 171a. The activated SBG element 31c now diffracts the S-polarized component of light 171a into a direction out of the plane of FIG. 17B as the light 192. The QWP converts the light 192 into circularly polarized light of a second sense 193 which is captured by a light stop 37. The incident P-polarized component of light 171a, which is not diffracted, continues to propagate along the optical axis in the directions 201a and is converted to circularly polarized light of a first sense 202a before being captured by the second light absorbing stop 37. The process illustrated in FIG. 17 is repeated for LEDs 1b and 1c with the ray paths in being indicated by the same numerals and letters b and c respectively.

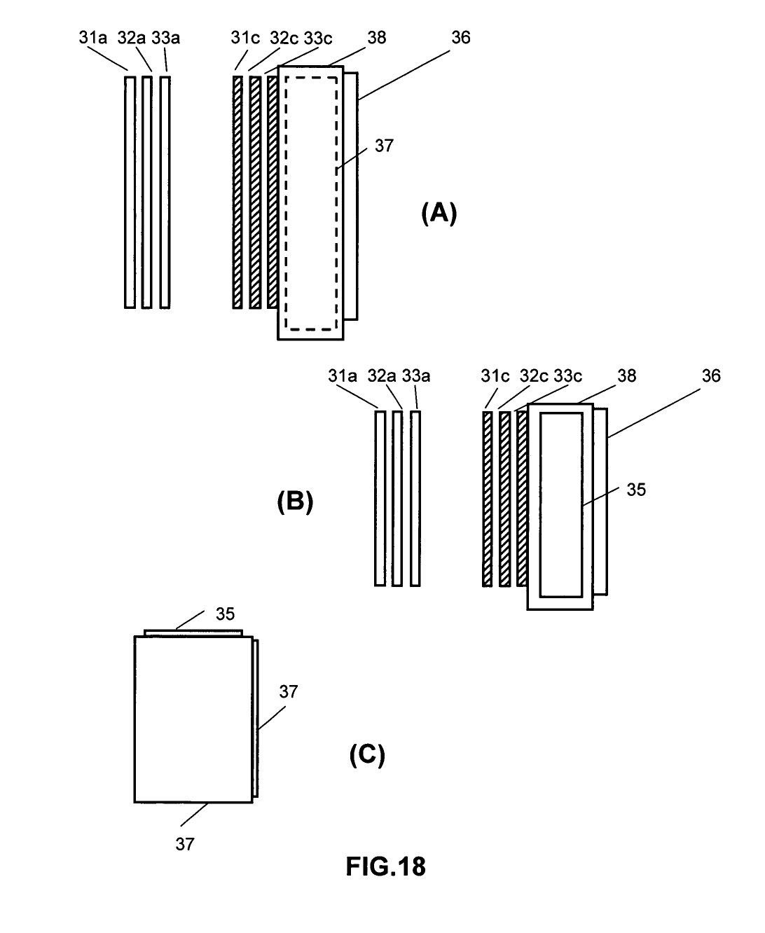

In one embodiment of the invention stops 35 and 37 may comprise light absorbing layers applied to the edges of a total internal reflection light guide 38 as illustrated in FIG. 18. The light guide is shown in side elevation view in FIG. 18A and plan view in FIG. 18B. A front projection is provided in FIG. 18C. The invention does not assume and particular method for disposing of stray light. Other methods will be known to those skilled in the art of optical design. The light guide may be very thin and presents no obscuration to the illumination light. Anti reflection coatings may be applied to one or both transmitting surfaces to reduce Fresnel reflection losses.

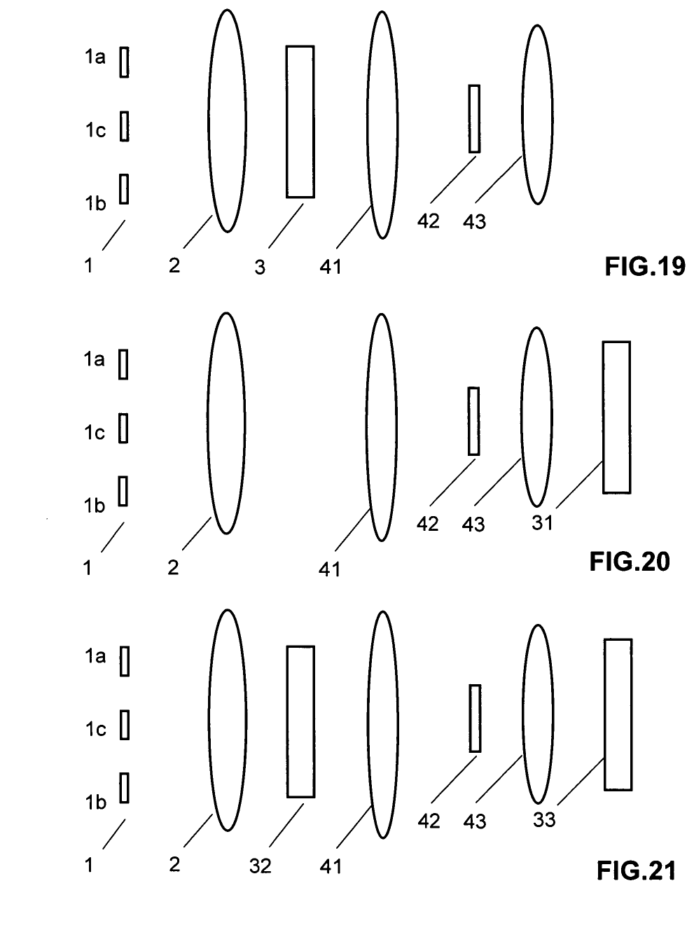

Although the first SBG device is integrated within the illuminator between the condenser lens and the display panel in the above described embodiments of the invention the invention places no restriction on where the first SBG device is located. Desirably for optimum diffraction efficiency the first SBG device should be in a reasonably collimated beam path. However, the inventors have found that transmission SBGs are capable of provide high efficiencies in beams having divergence greater than thirty degrees. In the embodiment of FIG. 19 in which the components of the illuminator are indicated using the numerals of FIG. 1 the first SBG device 3 which may be similar in design to the ones in any of the above described embodiments is disposed immediately after the condenser lens.

In the embodiment of the invention shown in FIG. 20 the first SBG device indicated by 31 is disposed after the projection lens.

In the embodiment of the invention shown in FIG. 21 there are provided two separate SBG devices one of them 32 disposed within the illuminator after the condenser lens and the other 33 disposed after the projection lens. The SBG devices may be identical devices according to the principles of any other above described embodiments. The SBG devices 32,33 may comprise subsets of the SBG groups used in any of the embodiments. For example, in one embodiment of the invention SBGs designed to diffract red and blue wavelengths may be disposed inside the illuminator and SBGs designed to diffract green light may be disposed after the projection lens. Many other combinations of SBGs will be apparent to those skilled in optical design.

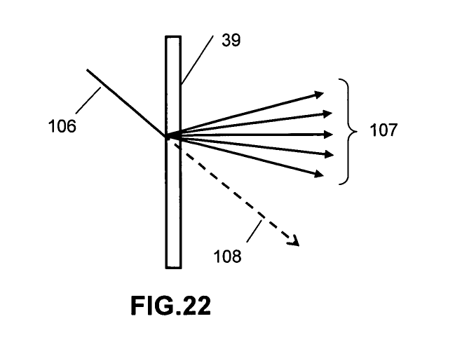

In the above describe embodiments of the invention the SBGs perform the function of beam deflectors. A given input ray is deviated into the required output direction according to the Bragg equation. In any of the above embodiments of the invention the SBGs may be operative to convert input light into diffuse light. The principles of encoding diffusion into holographic optical elements are well known. The inventors have found that SBGs encoding diffusion have very similar polarization characteristics to SBGs that act as simple beam deflectors providing high diffraction efficiency for P polarized incident light and very efficiency for S-polarized incident light. FIG. 22 is a schematic side elevation view of an SBG 39 designed to convert an incident ray 106 into a multiplicity of diffuse light rays generally indicated by 107.

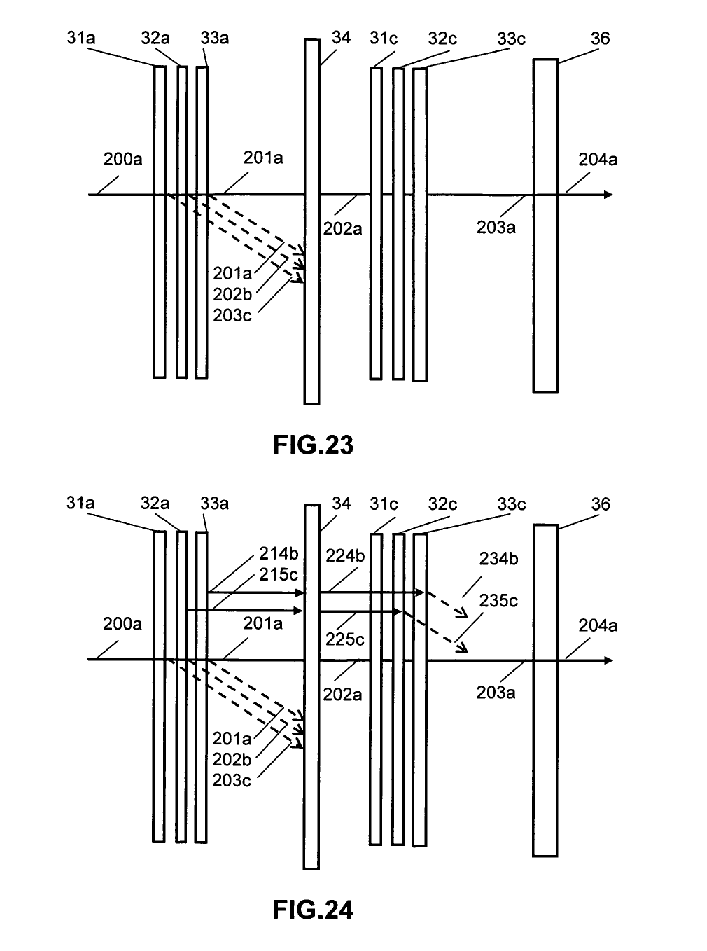

In one embodiment of the invention shown in the schematic side elevation view of FIG. 23 there is provided a first SBG device comprising the apparatus of FIG. 8 in which colour sequential polarization switching is provided by deflecting unwanted S and P light away from the illumination path of the first SBG device. The illumination path corresponds to the optical axis of the SBG device. The embodiment of FIG. 23 is directed at providing improvements to polarization contrast and colour purity. Polarization contrast characterizes the extent to which output light of a particular polarization is corrupted by the presence of small amounts of light having the wrong polarization. The unwanted polarization light may arise from inefficient diffraction by the SBGs. The issue of colour purity arises when the emission spectrum of a LED does not match the diffraction efficiency spectrum of the SBG used to diffract that wavelength band. For example in the case of green LEDs typical SBG diffraction efficiency bandwidths are not wide enough to cover the LED emission spectrum. In the above embodiments it has been assumed that any time only one SBG corresponding to the color and polarization state is active. The inventors have found that a very effective solution for overcoming spectral purity problems is to activate all SBGs in a P or S group simultaneously. The inventors have also discovered that if all SBGs in both groups are activated simultaneously it is possible to provide high spectral purity and high polarization contrast simultaneously. However, if all three SBGs in a particular S or P diffracting polarization group are active the effective bandwidth is increased. For example in the case of green the active green SBG diffracts the bulk of the green LED emission while the red and blue SBGs diffract the portions of the spectrum near the blue and red ends of the spectrums.

Turning to FIG. 23 we consider the case when the green LED is on. The first group of SBGs 31a,32a,33a diffracts green, red and blue P-polarized light respectively. The second group of SBGs 31c,32c,33c diffracts green, red and blue S-polarized light respectively. We consider incident green unpolarized axial light 200a. All SBGs are in the active state. Incident P-polarized green light 200a is diffracted into directions 201a. Incident P-polarized green light in a wavelength band overlapping with the efficiency bandwidth of red SBG is diffracted into the direction 202a. In a similar fashion, the incident P-polarized green light in a wavelength band overlapping with the efficiency bandwidth of blue SBG is diffracted into the direction 203a. The remaining axial S-polarized light 201a strikes the HWP 34 and is converted into axial P polarized light 202a. Since the second group of SBGs diffracts S-polarized the light the light 202a propagates as P-polarized light 203a incurring a small loss due to absorption and Fresnel surface reflection. The light 203a is converted to circularly polarized light by the QWP 36. The diffracted light may be trapped by directing it through the HWP and the second SBG group onto a stop. Alternatively the diffracted light is directed out of the main light path by using the SBG substrate as a light guide. The invention does not rely on any particular method for trapping the diffracted light. It will be clear from consideration of FIG. 23 that the principles illustrated also apply to the diffraction of S-polarized incident light by the second SBG group to provide output S-polarized light.

FIG. 24 illustrates the process of increasing polarization contrast in more details. The rays 214b, 215c represent P-polarized light not diffracted by the SBGs 32a, 33a. The rays 214b,215a strike the HWP and are converted into the S polarized rays 224a,225a. The rays 224a,225a are diffracted by SBGs 32c,33c as light 234a,235a which is directed to a stop which is not shown in FIG. 37.

It will be appreciated from the above description that the principles of the embodiment illustrated in FIG. 23 may also be applied to a first SBG device similar to the one of FIG. 4 in which the first SBG device does not use a circular polarizer.

It will also be appreciated from the above description that principles of the embodiment of FIG. 23 may also be applied to embodiments of the invention in which the first SBG device does not contain a HWP.

In the above described embodiments of the invention the first SBG device is designed to generated colour sequential polarization selective beams for illuminating a microdisplay. In another embodiment of the invention to be described in the following paragraphs there is provided a colour illuminator comprising separate red, green and blue SBG illumination devices each operating according to the principles described above.

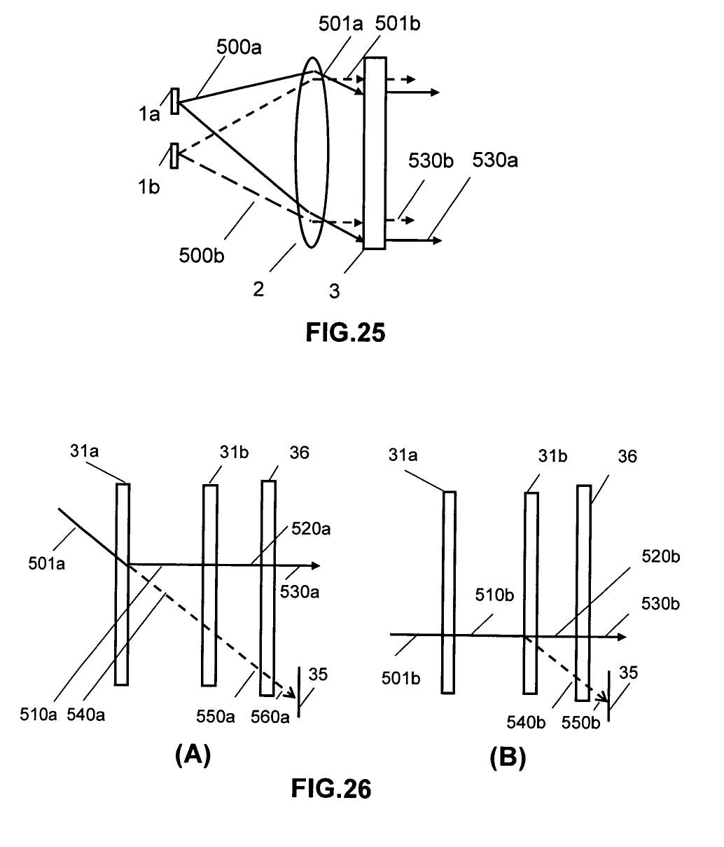

In one embodiment of the invention illustrated in the schematic side elevation view of FIG. 25 the first SBG is designed to operate with light from two identical LEDs 1a,1d each emitting light at a first wavelength. The first SBG device has an input optical port facing the condenser lens and an output optical port. The first SBG device comprises identical first and second SBGs 31a,31b and a QWP 36. The LED 1a is disposed such its peak emission is along the optical axis defined by the condenser lens 2 and the first SBG device 3. The LED 1b is disposed with its peak emission direction at an angle to said optical axis. The LEDs 1a,15 emit the unpolarized divergent beams 500a,500b which are collimated by the condenser lens 2 to provide the beams 501a,501b directed at the input port of the first SBG device. As will be explained next the first SBG device converts the input light 501a,501b into the P-polarized output light 530a and the S-polarized output light 530b.

The LEDs are pulsed with the SBGs 31a,31b being switched on and off in phase with the LEDs. Switching the LEDs and SBGs in this fashion is motivated by the fact that more efficient use of LED emission may be achieved by running both LEDs simultaneously using 50% duty-cycle. In other terminology, the LEDs are operated pulse sequentially. A gain of ×2 compared with running the same LEDs in continuous mode may be achieved using the above strategy. A further benefit is that the larger effective cooling area resulting from two well separated LEDs allows manufacturers' maximum LED drive current ratings to be maintained more efficiently.

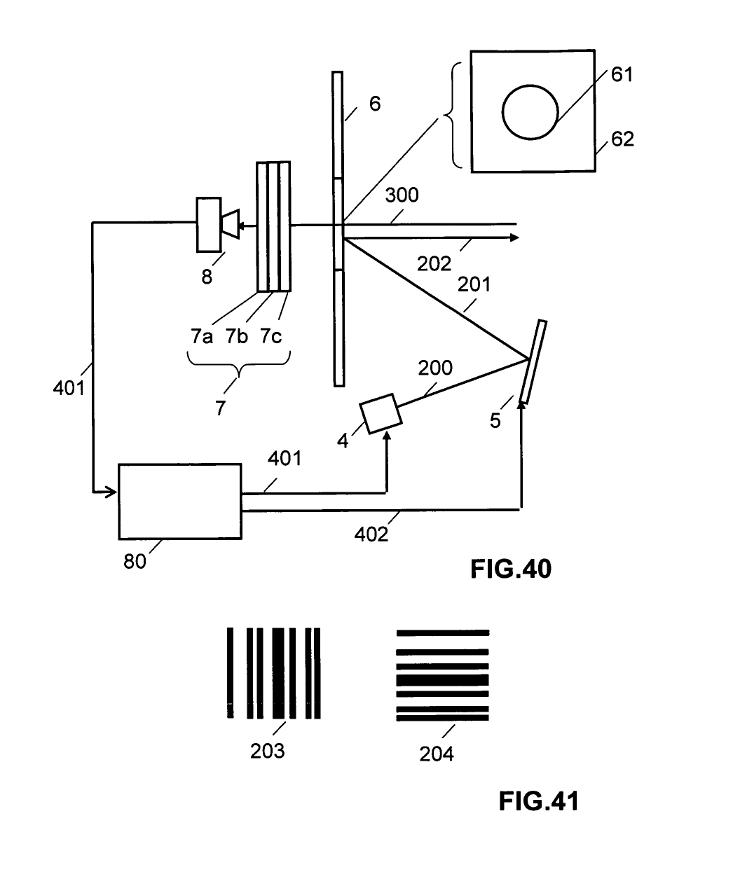

The operation of the first SBG device is illustrated schematically in FIGS. 26A-26B. Referring first to FIG. 26A, which provides a schematic side elevation view of a first state of the illuminator, we see that when the SBG 31a is in its diffracting state, the SBG 31b is in its non diffracting state, LED 1a is on and LED 1b is off. We consider the propagation of the collimated beam 501a. The P-polarized component of the beam 501a is diffracted by the SBG 31a into a direction 510a parallel to the optical axis. The beam 510a is transmitted through the SBG 31b without significant transmission loss or beam path deviation to provide a collimated P-polarized axial beam 520a. The beam 520a is converted to first circularly polarized output light 530a by the QWP. The S-polarized component of the input light 501a is transmitted without significant deviation or attenuation through the SBG 31a as the beam 540a and through the SBG 31b as the beam 550a. The beam 550a is trapped by the stop 35. Turning now to FIG. 26B, which provides a schematic side elevation view of a second state of the illuminator, we see that when the SBG 31a is in its non diffracting state, the SBG 31b is in its diffracting state, LED 1a is off and LED 1b is on. We consider the propagation of the unpolarized axial collimated beam 501b. The beam 501b is transmitted through the SBG 31a without significant transmission loss or beam path deviation to provide a collimated unpolarized axial beam 510b. The S-polarized component of the beam 510b is transmitted without substantial deviation or attenuation through the SBG 31b to provide the light 520b which is converted to second circularly polarized output light 530b by to the QWP. Said second circularly polarized light is in an opposing sense to the first circularly polarized light 530a in FIG. 40A. The P-polarized component of the beam 510b is diffracted by the SBG 31b into a direction 540b away from the optical axis. The QWP converts the light 540b to circularly polarized light 550b which is then trapped by the stop 35.

The embodiment of FIGS. 25-26 works by sequentially rejecting S and P polarisation in sequence with the pulsing of the LEDs. It will be clear from consideration of FIGS. 25-26 that the embodiments illustrated therein may be used to provide separate red, green and blue illuminator modules. Such modules may be used in three panel projectors or alternatively may be used to provide separated red, green and blue illumination channels for a single panel projector.

In one embodiment of the invention the QWP in FIGS. 25-26 may be eliminated to provide linearly polarized output.

### A Particular 3D Display Embodiment

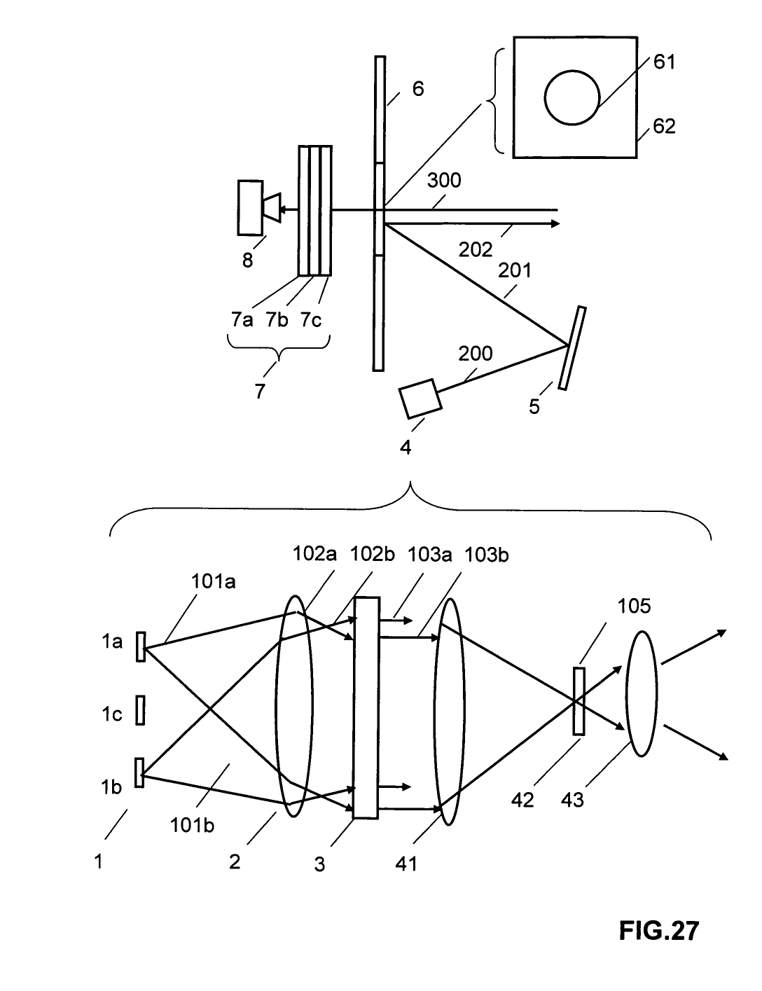

A display device according to the principles of the invention is illustrated in the schematic illustration of FIG. 27. The display comprises a LED module generally indicated by 1 comprising the red green and blue emitters 1a,1b,1c, a condenser lens system generally indicated by 2, a first switchable grating device 3, a relay optical system generally indicated by 41, a microdisplay panel 42 and a projection lens system generally indicated by 43, a beam folding mirror 5, a holographic screen 6, a second switchable grating device 7, and at least one miniature image sensor 8 comprising an arrays of photosensitive elements and a miniature objective lens. The elements 1a, 1b, 1c, 2, 3, 41, 42, 43, which together provided an image projection device are also indicated by the element 4, which provides output image light indicated by 200.

The second switchable grating device shown in FIG. 27 comprises a stack of red, green and blue SBGs disposed behind the screen and overlapping the aperture 61. The second SBG device performs the function of sequential filtering external light as will be discussed below

In one embodiment of the invention one image sensor is used. In the preferred embodiment of the invention a pair of image sensors is configured to record left and right eye perspective views are provided. Advantageously, each image sensor is mounted at a nominal eye height. Optical access for the image sensors is provided via the screen aperture 61.

In the embodiment of FIG. 27 the screen is a reflective holographic screen polarization preserving screen operative to diffract light incident at an oblique angle into a direction substantially normal to the screen surface towards the viewer. Holographic screen materials suitable for use with the present invention are manufactured by Luminit LLC (CA). Conventional silver screens used in cinemas will also have polarization preserving characteristics. However, conventional screens are not effective at large bend angles.

In many applications the mirror 5 may be fixed. However, it is desirable that the mirror is adjustable to accommodate varying viewer eye heights. In one embodiment of the invention the mirror may have a motorized drive.

It will be clear from consideration of FIG. 27 that the apparatus illustrated therein provides an illuminator, an image generator and a complete stereoscopic image display. The elements 1,2,3 of FIG. 1 together provide an illuminator for providing sequential S and P polarized illumination light. The elements 1, 2, 3, 41, 42, 43 together provide an image generator that provides alternate orthogonally polarized left and right eye image light for stereoscopic viewing. The elements 1, 2, 3, 41, 42, 43, 5, 6, 7, 8 may provide a display device that generates alternate orthogonally polarized (or opposing sense circularly polarized) left and right eye images for stereoscopic viewing. Said images are viewed through a pair of glasses containing a pair of orthogonal polarizing filters (or circular polarizers). As each filter only passes light which is similarly polarized and blocks the orthogonally polarized light each eye sees only one of the images providing the stereoscopic effect. It will be clear from consideration of the above description of the invention that any of the embodiments for providing alternately orthogonally polarized illumination may be used to provide the display illustrated in FIG. 27.

Turning again to FIG. 27, the image light 200 is reflected towards the screen 6 by the mirror 5 to provided image light 201 which is reflected towards the viewer as the light 202. The screen contains a small aperture for admitting light 300 reflected from the human operator which is shown as a detail of FIG. 27 indicating the aperture 61 and surrounding screen portion 62. As will be explained in more detail below, the light 301 transmitted through the screen aperture 61 is colour sequentially filtered by the second SBG device and imaged by the sensor 8. It should be noted that in FIG. 27 and in the following illustrations the relative dimensions of the components shown therein have been exaggerated to assist in explaining the principles of the invention. The aperture 61 is small enough to be effectively invisible to the operator.

In one embodiment of the invention a linear polarizer selecting the P-polarization component of light transmitted from the external scene towards the camera is disposed adjacent to the screen aperture.

In one embodiment of the invention the camera is equipped with a freeze frame shutter. Such a mechanism freezes and stores the complete frame for one colour field while exposing the image corresponding to the next colour field.

In one embodiment of the invention an optical filter may be disposed adjacent to the screen aperture for the purposes of controlling stray light. Said stray light may comprise light from the projected beam that is not reflected towards the operator or ambient illumination striking the operator side of the screen.

The screen 6 is design to deflect light incident at a steep angle into a direction substantially normal to said screen. Advantageously the screen is polarization preserving.

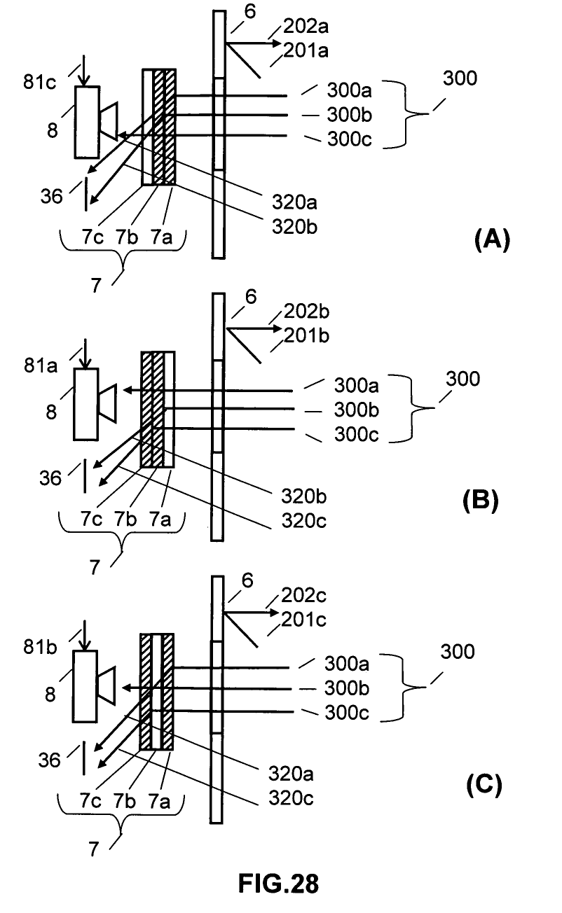

In one embodiment of the invention there is provide a method and apparatus for recording an image of image of the operator using the image sensor 8. Turning now to FIG. 28 which shows a detail of FIG. 1 including the screen 6 the second SBG device 7 and the camera 8, we see that the light reflected from the operator towards the screen 6 comprises red green and blue components indicated by 300A,300B,300C. Typically, the operator will be illuminated by the local room lighting or an illuminator disposed at the workstation. The left and right eye red green and blue image components may be transferred to other work stations such that an image of the operator may be reconstructed on communicating work station screens. The camera is configured to record sequential red, green, blue sub-frame images of the operator. The second SBG device 6 acts as a colour sequential light rejection filter rejecting red, green, and blue light sequentially out of the camera path. The SBG device comprises blue, green and red diffracting SBGs 7a,7b,7c. The apparatus further comprises a light stop generally indicated by 36. Since the external illumination will be randomly polarized and SBGs do not diffract S-polarized light, the apparatus of FIG. 8 further comprises a linear polarizer for selecting the P-polarization component of light transmitted from the external scene towards the camera is disposed adjacent to the screen aperture. Alternatively, the linear polarizer may be disposed at some other position in the optical train from the screen aperture to the imaging sensor.

The process of sequentially transmitting red green blue light reflected from the operator is shown in the three steps illustrated in FIG. 28A-28C in which the incident light is indicated again by 300a,300b,300c and red green and blue projected and reflected light is indicated again by 201a,202a,201b,202b201c,202c.

In the first step shown in FIG. 28A the red diffracting SBG 7c is deactivated and the SBGs 7a,7b are activated. Blue projection light indicated by 201c is incidence on the screen and is reflected as light 202c. The camera 8 is switched to its red image sub frame by an electrical signal indicated by 81c. Incident blue and green light 300a,300b from the operator are diffracted by the SBGs 7a,7b to provide the diffracted light 320a,320b which is trapped by the stop 36. Incident red light passes through the SBGs without deviation and is imaged by the camera 8.
In the second step shown in FIG. 28B the green diffracting SBG 7b is deactivated and the SBGs 7a,7c are activated. Green projection light indicated by 201b is incidence on the screen and is reflected as light 202b. The camera 8 is switched to its green image sub frame by an electrical signal indicated by 81b. Incident red and green light 300c,300b from the operator are diffracted by the SBGs 7a,7c to provide the diffracted light 320c,320b which is trapped by the stop 36. Incident red light from the operator passes through the SBGs without deviation and is imaged by the camera 8.
In the third step shown in FIG. 28C the blue diffracting SBG 7c is deactivated and the SBGs 7a,7b are activated. Red projection light indicated by 201a is incidence on the screen and is reflected as light 202a. The camera 8 is switched to its blue image sub frame by an electrical signal indicated by 81a. Incident blue and red light 300a,300c from the operator are diffracted by the SBGs 7a,7b to provide the diffracted light 320a,320c which is trapped by the stop 36. Incident red light from the operator passes through the SBGs without deviation and is imaged by the camera 8.

The scheme discussed in the above paragraphs and illustrated in FIGS. 28A-28C avoids the problem of the camera being saturated by projected image light while recording light of the same wavelength reflected from the operator. For example during the red-projected sub frame the red diffracting SBG of the second SBG device 6 is activated such that red incident light which would normally saturate the camera is deflected out of the beam path and trapped. At the same time the camera takes a blue sub frame image of the operator.

It will be clear from consideration of the above paragraphs and FIGS. 28A-28C that the invention may be practiced with using alternative equivalent schemes for synchronizing colour sequential image light with the switching of the SBGs 7a,7b,7c to ensure that at any time the camera records light of a different wavelength to the one being projected.

A method of capturing colour sequential colour imagery and projecting colour sequential imagery using a single camera using the apparatus of FIG. 28 comprises the following steps
a) Providing a second SBG device comprising a stack of red, green and blue diffracting SBGs;
b) Providing a screen disposed between said stack of SBGs and an operator, said operator reflecting light from an external source towards said SBG stack;
c) Providing a camera disposed on the opposite side of the SBG device to the incoming light;
d) Providing an optical port within said screen that allows the camera to view the operator;
e) Providing a polarizer disposed within the aperture of the optical port to convert the light reflected from the operator into P-polarized light;
f) Switching said camera to its red image sub-frame by means of a control signal 81c
g) Deactivating SBG 7c and activating SBGs 7a,7b;
h) Projecting blue image light from an external colour sequential image projection means onto said screen;
i) Diffracting external light 300a,300b at SBGs 7a,7b to provide P-polarized diffracted light 320a,320b and transmitting external light 300c towards the camera;
j) Trapping light 320a,320b at the stop 36;
k) Forming an image from the light 300c;
l) Switching said camera to its blue image sub-frame by means of a control signal 81a;
m) Deactivating SBG 7a and activating SBGs 7b,7c;
n) Projecting green image light from an external colour sequential image projection means onto said screen;
o) Diffracting external light 300b,300c at SBGs 7b,7c to provide P-polarized diffracted light 320b,320c and transmitting external light 300a towards the camera;
p) Trapping light 320b,320c at the stop 36;
q) Forming an image from the light 300a;
r) Switching said camera to its green image sub-frame by means of a control signal 81b;
s) Deactivating SBG 7b and activating SBGs 7a,7c;
t) Projecting red image light from an external colour sequential image projection means onto said screen;
u) Diffracting external light 300a,300c at SBGs 7a,7c to provide P-polarized diffracted light 320a,320c and transmitting external light 300b towards the camera;
v) Trapping light 320a,320c at the stop 36;
w) Forming an image from the light 300b;

A method of capturing colour imagery using a single camera using the apparatus of FIG. 28 comprises the following steps
a) Providing an SBG device comprising a stack of red, green and blue diffracting SBGs;
b) Providing a camera disposed on the opposite side of the SBG device to the incoming light;
c) Transmitting external light reflected from the operator through a polarizer to provide P-polarized light
d) Deactivating SBG 7a and activating SBGs 7b,7c;
e) Diffracting external light 300b,300c light SBG 7a to provide P-polarized diffracted light 310b,310c and transmitting external light 300a towards the camera;
f) Trapping light 310b,310c at the stop 36;
g) Forming an image from the light 300a;
h) Deactivating SBG 7b and activating SBGs 7a,7c;
i) Diffracting external light 300b,300c light SBG 7b to provide P-polarized diffracted light 310a,310c and transmitting external light 300b towards the camera;
j) Trapping light 310a,310c at the stop 36;
k) Forming an image from the light 300b;
l) Deactivating SBG 7c and activating SBGs 7a,7b;
m) Diffracting external light 300a,300b light SBG 7c to provide P-polarized diffracted light 310a,310b and transmitting external light 300c towards the camera;
n) Trapping light 310a,310b at the stop 36;
o) Forming an image from the light 300c;

In one embodiment of the invention the operator may be illuminated by ambient room light. In one embodiment of the invention the operator may be illuminated by colour sequential red green and blue light synchronized with the camera red, green and blue sub-frames respectively.

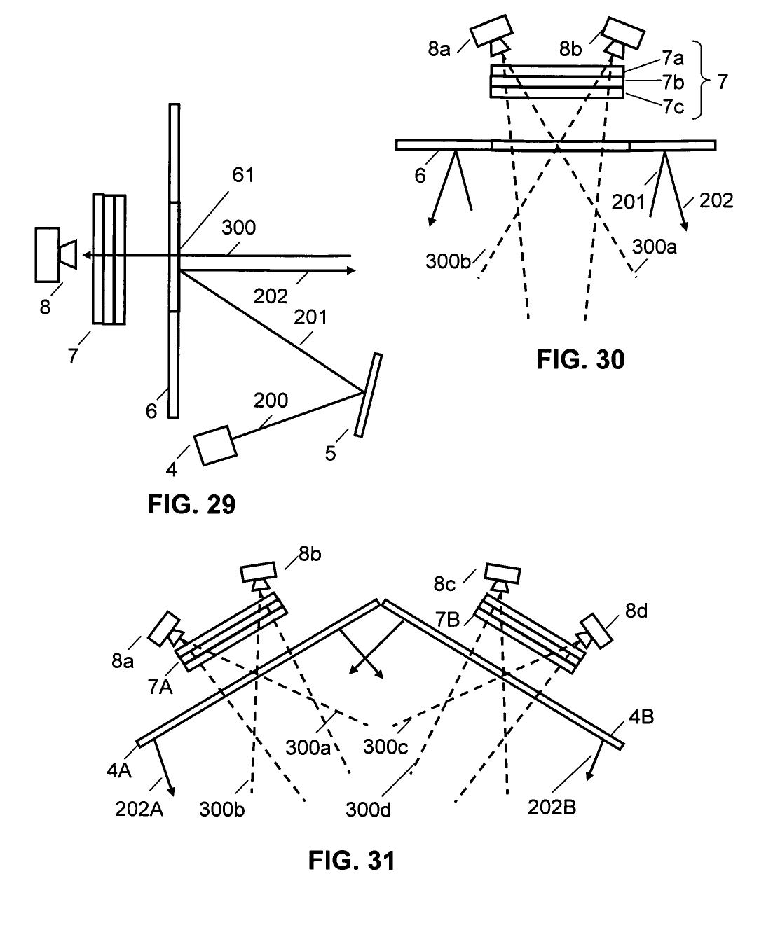

The apparatus of FIG. 28 provides a monoscopic image of the operator. To provide stereoscopic images two cameras are required as illustrated in the schematic side elevation view of FIG. 29 and the schematic plan view of FIG. 30. The pair of stereoscopic sensors are indicated by 8a,8b. The process of recording red green and blue images sequences for each camera is identical to the one described above in relation to the embodiment of FIG. 28.

In one embodiment of the invention the pair of stereoscopic sensors capture image light through a common aperture as indicated in FIG. 30. The left and right perspective light from the operator propagates through the SBG device 7. Such an embodiment will require highly miniaturized sensors. In an alternative embodiment of the invention the sensors may use separate apertures. In such embodiments separate second SBG devices may be provided for each sensor.

In one embodiment of the invention directed at providing face-to-face communication between operators the colour sequential image sequences from each sensor are transmitted as left and right eye perspective views to a remote terminal. The microdisplay at the remote terminal then displays the transmitted sequential left and right eye views.

In one embodiment of the invention two or more identically display screens may be combined to provide a wrap around display. For example in the embodiment of FIG. 31 a wraparound display based on the display of FIG. 30 comprises screens 4A,45, second SBG devices 7A,7B and cameras 8a,8b,8b,8c. with overlapping fields of view 300a,300b,300c,300d. In alternative embodiments of the invention fewer cameras may be used. The projection light paths of the wraparound screen reflects projection beams are similar to those illustrated in FIGS. 29-30 the output light beams being indicated by 202A,202B.

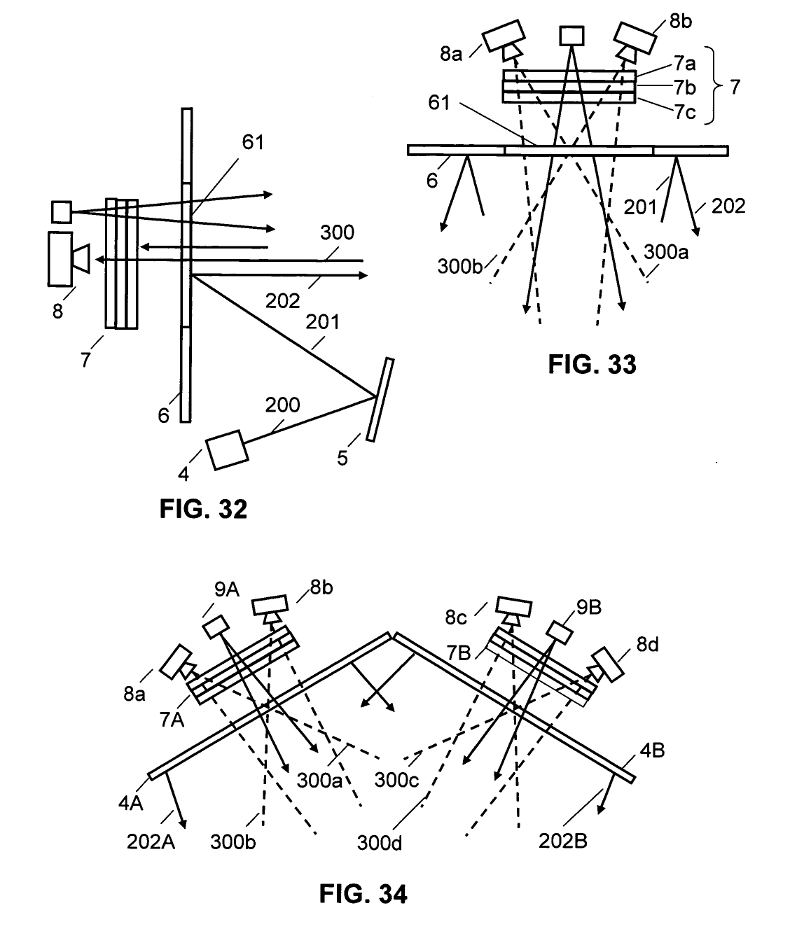

In one embodiment of the invention illustrated in FIGS. 32-34 similar to the one illustrated in FIGS. 29-30 there is further provided a device for projecting structured light towards the viewer. Structured light is the process of projecting a known pattern which typically might comprise vertical or horizontal grids or horizontal bars on to a scene. The way in which the grids deform when striking surfaces allows vision systems to calculate the depth and surface information of the objects in the scene. Advantageously more than one camera is used to allow geometrical distortions of the grids to be measured from difference perspectives allowing greater accuracy in the reconstration of the 3D surface. Typically such configuration use two cameras to capture stereo image pairs of structured light illuminate subjects.

Structured lighting may use lasers allowing patterns to be generated by interference or diffractive optical elements. Alternatively, incoherent sources may be used with the generation of the pattern relying on masks, such as Ronchi grids. One known group of methods for generating patterns uses spatial light modulators such as LCDs or DLPs.

To avoid interfering with other tasks being carried out by the workstation it is advantageous to use infrared for the structured light. In one embodiment of the invention the structured light projector comprises at least an infrared emitter, condenser lens, a mask containing the pattern to be projected and a projection lens. The invention does not rely on any particular method for projecting structured light.

In one embodiment of the invention the projected structured light and backscattered structured light may use the same screen aperture as the visible light. The scattered and reflected light from then illuminated subject is recorded by the image sensor. The structure light may be used for a number of purposes. In one embodiment of the invention the structure light is used for eye tracking. In one embodiment of the invention the structured length is used for head tracking.

In one embodiment of the invention structured lighting is used for recognition of objects being held or manipulated by the operator. In one embodiment of the invention the structured lighting is used to analyse operator facial expressions and gestures. Such an embodiment of the invention could be used to enable a robot in a remote location to couple the operators movements in a processes known as teleoperation

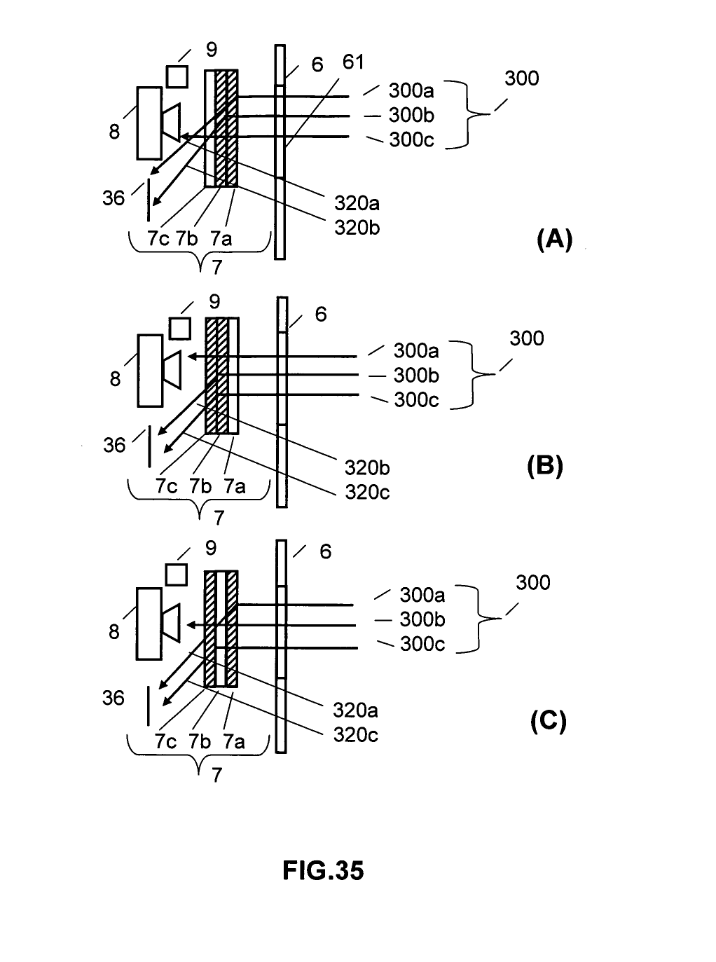

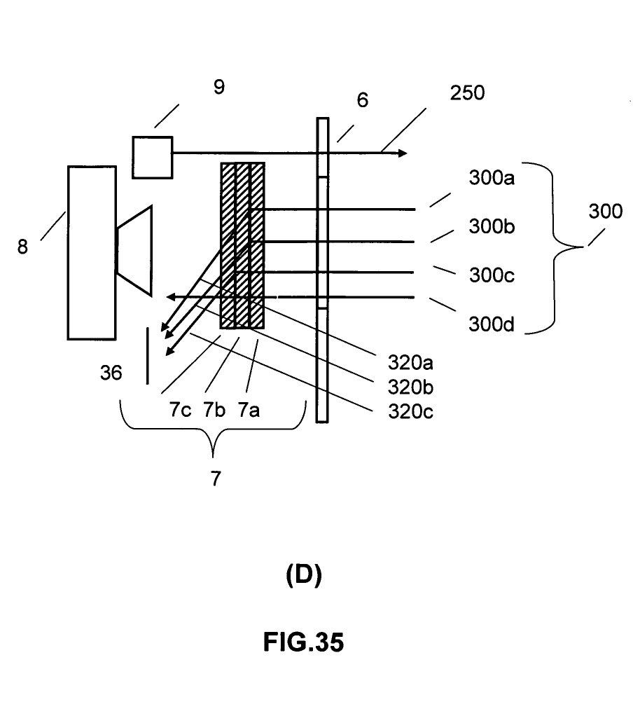

The process of providing structured lighting as discussed above and imaging red green blue light from the viewer is shown in the four steps illustrated in FIG. 35. The apparatus of FIG. 35 is identical to that of FIG. 28 except that there is further provided an apparatus 9 for projecting structured infrared light and additional SBG layer 7 operative to diffract infrared light of the same wavelength as said structured infrared light. The first three steps as indicated by FIG. 35A-35C are identical to the three steps illustrated in FIG. 28. However, in the fourth step shown in FIG. 35D the SBGs 7a,7b,7c are activated. The infrared structured light projector is activated and emits the structured light beam generally indicated by 250. Incident red, green and blue light are diffracted by the SBGs 7a,7b,7c to provide the diffracted light 320a,320b,320c which is trapped by the stop 36. Incident infrared light scattered from the illuminated subject passes through the SBGs without deviation and is imaged by the camera 8. Structured light scattered back from the viewer 320d is image by the sensors.

Advantageously, the infrared light used for the structure lighting has a narrow spectral bandwidth to allow it to be separated from ambient infrared light.

In one embodiment of the invention for providing structures lighting the stack of SBGs shown in FIG. 28 may further incorporate an infrared diffracting layer the infrared diffracting layer may be used to eliminate ambient infrared light from the imaging optical path.

In one embodiment of the invention the screen has separate ports for visible light and infrared light. In one embodiment of the invention the screen may separate ports for infrared and visible light.

In any of the above described embodiments of the invention the LED sources may be replaced by lasers. Lasers provide scope of extremely bright, reliable, efficient, compact and cost effective devices. True life-like colour images are only possible with lasers, which provide colour gamuts covering 90% of what the eye sees, surpassing by far LEDs and other incoherent sources. Laser displays suffer from speckle. Easily recognisable as a sparkly or granular structure around uniformly illuminated rough surfaces, speckle arises from the high spatial and temporal coherence of lasers. The resulting viewer distraction and loss of image sharpness is a major obstacle to commercialisation of laser projectors. The benchmark for most applications is a speckle contrast of less than 1% (speckle contrast being defined as the ratio of the standard deviation of the speckle intensity to the mean speckle intensity). Although methods of eliminating speckle have been proposed since the first demonstrations of lasers an efficient and elegant solution has proved elusive. Mechanical methods such as rotating diffusers and vibrating screens suffer from the problems of noise, mechanical complexity and size. Other passive techniques using diffractive, MEMs or holographic elements, microlens arrays and others have met with limited success.

There are two types of speckle: objective and subjective speckle. Objective speckle results from scattering in the illumination system while subjective speckle occurs at the projection screen. As its name implies, objective speckle is not influenced by the viewer's perception of the displayed image. In more fundamental terms objective speckle arises from the uneven illumination of an object with a multiplicity of waves that interfere at its surface. Subjective speckle arises at rough objects even if they are illuminated evenly by a single wave. A photographic emulsion spread over the surface of the object would record all of the key characteristics of objective speckle. Even a perfect optical system cannot do better than to reproduce it exactly. The screen takes the objective speckle pattern and scatters it into the viewing space. The human eye only collects a tiny portion of this light. Since the objective speckle acts like a coherent illumination field, the diffusion of the screen produces a new speckle pattern at the retina with a different speckle grain. This is the subjective speckle pattern. While subjective speckle may be influenced by screen diffuser materials and lenticular structures it is essentially a function of the eye's lens aperture. The cumulative speckle seen by the eye is the sum of the objective and subjective speckles.

Removing the objective speckle is relatively easy since the speckle pattern is well transferred from the illumination to the screen: any change in the illumination will be transferred to the screen. Traditionally, the simplest way has been to use a rotating diffuser that provides multiplicity of speckle patterns while maintaining a uniform a time-averaged intensity profile. This type of approach is often referred to as angle diversity.

Suppression of subjective speckle is much more difficult. Because of large disparity between the projection optics and eye optics numerical apertures (or F-numbers), the objective speckle grain is significantly larger than subjective speckle grain. Therefore, the objective speckle provides a relatively uniform illumination to the screen within one resolution cell of the eye regardless of the position of the rotating diffuser or other speckle reduction means in the illumination path. For the purposes of quantifying the subjective speckle it is convenient to define the speckle contrast as the ratio of the resolution spots of the eye and the projection optic at the screen. “Subjective” speckle occurs at the projection screen and is eye dependent. The most commonly cited remedy for subjective speckle is to use a fast projection lens, ie with an F-number of F/1.0 or faster. However, this does not offer a complete solution.

In general, subjective speckle dominates in front projection systems while objective speckle is more important in RPTV. In front projection it is estimated that subjective speckle accounts for 85-90% of observed speckle. Subjective speckle is difficult to eliminate in front projection. One known solution is to vibrated screens or other optical elements in the projection path.

The present invention may use the laser despeckling techniques disclosed in the PCT application PCT/IB2008/0019099 with International Filing date 22 Jul. 2008 entitled “LASER ILLUMINATION DEVICES” and U.S. Provisional Patent Application No. 61/136,309 filed 27 Aug. 2008 entitled “LASER DISPLAY INCORPORATING SPECKLE REDUCTION”, both of which are incorporated by reference herein in their entireties.

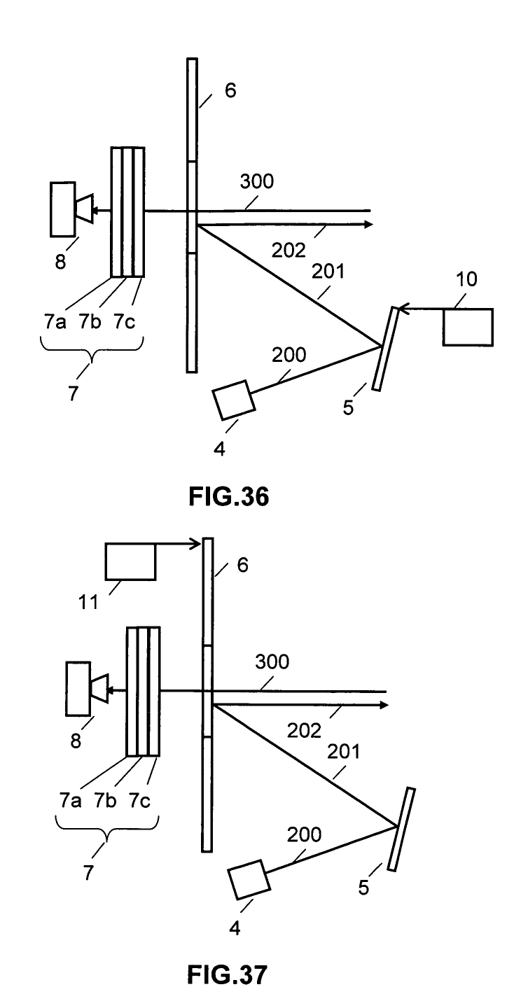

In one embodiment of the invention illustrated in FIG. 36 despeckling of the image is provided by vibrating the mirror using the mechanical vibration device indicated schematically by 10.

In one embodiment of the invention illustrated in FIG. 37 could provide despeckling by vibrating the screen using the mechanical vibration device indicated schematically by 11.

A common design goal in building any projection display system is to minimize the throw ratio, without sacrificing image quality. The throw ratio is defined as the ratio of the distance from the screen of the projector to the size of the projected image diagonal. Minimizing the throw ratio is especially important for rear projection systems in which the projector and screen are physically combined into one unit. In such units minimizing the throw ratio implies a smaller cabinet depth, which houses the screen and projector. To decrease the throw ratio, prior art methods have combined planar mirrors with low distortion and wide field of view (FOV) lenses to fold the optical path, which serves to decrease the projection distance, hence decreasing the throw ratio. By fine-tuning the optical geometry it can be assured that image distortions are minimized. This has the disadvantages of requiring optical elements that are difficult to design and expensive to manufacture and restricting the sizes/placement of the optical elements. The optical and geometric constraints manifest as pincushion or barrel distortion and keystone distortions.

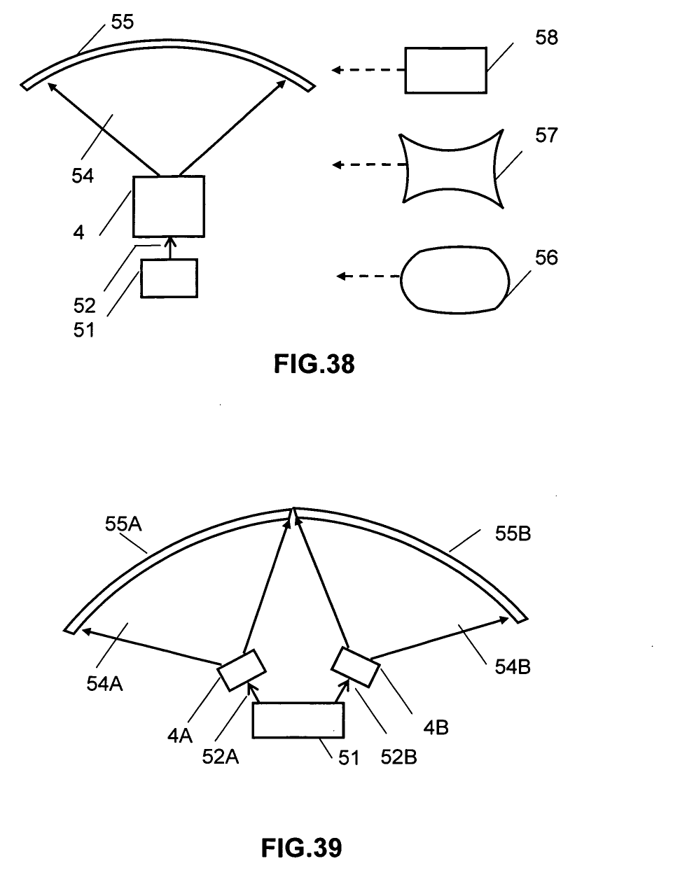

In one embodiment of the invention a display device may further incorporate means for correcting image distortion. Referring to the schematic illustration FIG. 38 a short throw projection display comprises an electronic image correction module 51 connected via a data link 52 to a display device according to any of the embodiments of FIGS. 27-37 indicated by 4. As indicated above the display 4 comprises a LED module generally indicated by 1 comprising the red green and blue emitters 1a,1b,1c, a condenser lens system generally indicated by 2, a first switchable grating device 3, a relay optical system generally indicated by 41, a microdisplay panel 42 and a projection lens system generally indicated by 43, a beam folding mirror 5, a holographic screen 6, a second switchable grating device 7, and at least one miniature image sensor 8 comprising an arrays of photosensitive elements and a miniature objective lens. The elements 1a, 1b, 1c, 2, 3, 41, 42, 43, together provided an image projection device. The display device 4 projects image light 54 onto a curved projection screen 55. The electronic image correction module applies a distortion function represented by 56 to the perfectly rectangular input image function. The geometrical distortion of the display device resulting from the projection geometry, screen curvature and the aberrations of optical components of the display device is represented by 57. The pre-distortion 56 and optical distortion 57 cancel to provide a perfectly rectangular image 58. The distortion function 56 is computed to provide a corrected screen image for a specified observer eye point.

In one embodiment of the invention the electronic correction unit may be further adapted to independently pre-distort the geometry of each primary color represented by the input image data and generate a pre-distorted primary color image data to compensate for differences in the optical refraction of each color, such that when the pre-distorted primary color image associated with the pre-distorted primary color image data is projected through the image projector to the projection screen, the optical and geometric distortions associated with each primary color optical image are eliminated.

In one embodiment of the invention the distortion correction scheme described above may be used to provide edge matching of images projected by two or more display devices as illustrated in FIG. 39. The apparatus of FIG. 39 comprises an electronic image correction module 51 connected via a data links 52A,52B to a first and second display devices 4A,4B. The display devices projects image light 54A,54B onto abutting curved projection screen portions 55A,55B.

In one embodiment of the invention directed there is provided a means for the aligning the projected images in a wraparound display such as the one illustrated in FIG. 31. Referring to FIG. 40 we see that the apparatus of FIG. 31 further comprises the control processor 80 which receives signals 401 from the image sensor and transmit control signals 402,403 to the display device 4 and the mirror 5. The display device 4 projects alignment patterns on to the screen. The patterns are traversed across the screen aperture in the vertical and horizontal directions using the mirror 5. The patterns may comprise bar codes such as the ones indicated by 203,204 in FIG. 41. The camera captures images of the patterns and compares them with factory settings stored in a look up table stored in the control processor. Using the data obtained from the comparison of the captured images and the factory settings the control processor computes and transmits control signals to the display device 4 and mirror 5. The display device and mirror in turn provide incremental adjustments to the projected image centration and the mirror orientation.

In one embodiment of invention a Diffractive Optical Element (DOE) is disposed after the first SBG device 3. The DOE alters the wavefronts of incident red green and blue light to control to spatial distribution of illumination at the display panel. The output from the DOE comprises diffused light. Non-uniformities to be corrected by the DOE may be contributed by the LED polar distributions, vignetting aberrations and other factors. Advantageously, the DOE is a Computer Generated Hologram (CGH) operative to diffract and diffuse red green and blue light.

The illuminator forms a diffused image of the LED die at an illumination surface which is typically close to the surface of the microdisplay.

The SBGs may also have diffusing properties that operate on light at the diffraction wavelength. The required diffusion characteristics may be built into the SBG devices using procedures well known to those skilled in the art of Holographic Optical Elements (HOEs). The diffusing properties of the SBGs and the CGH may be combined to produce a desired illumination correction.

The microdisplay may any type of transmissive or reflective array device. The microdisplay does not form part of the present invention.

Although the SBGs are illustrated as physically separated stacks in the drawings, in preferred practical embodiments of the invention the SBG layers in any of the above embodiments would be combined in a single planar multiplayer device. The multilayer SBG devices may be constructed by first fabricating the separate SBG devices and then laminating the SBG devices using an optical adhesive. Suitable adhesives are available from a number of sources, and techniques for bonding optical components are well known. The multilayer structures may also comprise additional transparent members, if needed, to control the optical properties of the illuminator.

It should be noted that in order to ensure efficient use of the available light and a wide color gamut, the SBG devices should be substantially transparent when a voltage is applied, and preferably should diffract only the intended color without an applied voltage.

The SBGs may be based on any liquid crystal material including nematic and chiral types.

The SBGs used in the first and second SBG devices may be based on transmission or reflection Bragg gratings.

It should be emphasized that the Figures are exemplary and that the dimensions have been exaggerated. For example thicknesses of the grating layers have been greatly exaggerated.

In one embodiment of the invention a light control film is applied to the screen 6 to block stray light that would otherwise reduce contrast and degrade color gamut. One known light control film manufactured by 3M Inc. (Minnesota) comprises an array of micro-sphere lenses embedded in a light-absorbing layer. Each lens provides a small effective aperture such that incident rays substantially normal to the screen, are transmitted with low loss as a divergent beam while incident rays, incident at an off axis angle, are absorbed. Other methods of providing a light control film, such as louver screens may be used as an alternative to the light control film described above.

It will be clear from consideration of the Figures that the optical systems used to implement the system may be folded by means of mirrors in order to provide more compact configurations. It will also be clear from consideration of the Figures that mirrors and sliding mechanisms know to those skilled in the art of opto-mechanical systems may be used to compress the optical system into a compact configuration.

Although the invention has been described in relation to what are presently considered to be the most practical and preferred embodiments, it is to be understood that the invention is not limited to the disclosed arrangements, but rather is intended to cover various modifications and equivalent constructions included within the spirit and scope of the invention.

What is claimed is:

1. An illumination device [4] comprising:
first and second light sources [1a,1b] emitting light at first and second wavelengths respectively and at first and second angles respectively;
a first SBG [31a] operative to diffract said first wavelength light;
a second SBG [32a] operative to diffract said second wavelength light;
a third SBG [31b] identical to said first SBG operative to diffract said first wavelength light; and
a fourth SBG [32a] identical to said second SBG operative to diffract said second wavelength light,
wherein each said SBG is operative to diffract light of a first polarization and transmit light of a second polarisation orthogonal to said polarization when in an active state and transmit light of any polarization without deviation when in an inactive state, characterised in that each of said first and third SBG is operative to diffract light at said first angle into a common direction
wherein each of said second and fourth SBG is operative to diffract light at said second angle into said common direction
wherein said illumination device provides output light of said first wavelength at said first polarisation when said first LED is on, said second LED is off, said first SBG is active and all other SBGs are inactive.
wherein said illumination device provides output light of said first wavelength at said second polarisation when said first LED is on, said second LED is off said third SBG is active and all other SBGs are inactive.
wherein said illumination device provides output light of said second wavelength at said first polarisation when said first LED is off, said second LED is on, said second SBG is active and all other SBGs are inactive.
wherein said illumination device provides output light of said second wavelength at said second polarisation when said first LED is off, said second LED is on said fourth SBG is active and all other SBGs are inactive.

2. The apparatus of claim 1 further comprising: a microdisplay [42]; and a projection lens [43], wherein said light transmitted in said common direction illuminates said microdisplay wherein said microdisplay modulates said first polarisation output light with left eye perspective image data, wherein said microdisplay modulates said second polarisation output light with right eye perspective image data.

3. The apparatus of claim 1 further comprising a quarter wave plate [36] disposed after said fourth SBG, wherein said quarter wave plate converts said first and second polarisation output light into first circular polarization sense and second circular polarisation sense output light.

4. The apparatus of claim 1 further comprising a half wave plate [34] disposed between said second SBG and said third SBG.

5. The apparatus of claim 1 wherein said third SBG and said fourth SBGs are each rotated through ninety degrees around an optical axis through said first, second, third and fourth SBGs.

6. The apparatus of claim 1 wherein said sources are LEDs

7. The apparatus of claim 1 wherein said sources are lasers

8. The apparatus of claim 2 wherein said left eye and right perspective image light is projected by said projection lens onto a screen for viewing by a human operator, wherein said human operator is equipped with spectacles 44 containing a pair of orthogonal polarizing filters [45a,45b].

9. The apparatus of claim 2 where said left eye and right perspective image light is projected by said projection lens onto a screen for viewing by a human operator, wherein said human operator is equipped with spectacles 44 containing a pair of circular polarizing filters of opposing senses [47a,47b].

10. The apparatus of claim 2 further comprising a movable mirror [5] disposed between said projection lens and said screen wherein said mirror is equipped with means [10] for displacing its reflecting surface backwards and forwards frequency characterised by a period much shorter than the integration time of then human eye.

11. The apparatus of claim 1 wherein said sources are lasers and further comprising a means for despeckling laser light.

12. The apparatus of claim 1 further comprising a condenser [2] lens disposed between said first and second light sources and said first SBG.

13. An illumination device comprising:
a first light source emitting light at a first wavelength and a first angle;
a first SBG operative to diffract said first wavelength light;
a second SBG identical to said first SBG operative to diffract said first wavelength light;
a quarter wave plate; and
a microdisplay,
wherein each said SBG is operative to diffract light of a first polarization and transmit light of a second polarisation orthogonal polarization when in an active state and transmit light of any polarization without deviation when in an inactive state,
characterised in that each SBG is operative to diffract light at said first angle into a common direction,
wherein said illumination device provides output light of said first wavelength at said first polarisation when said first light source is on, said first SBG is active and said second SBG is inactive,
wherein said illumination device provides output light of said first wavelength at said second polarisation when said first light source is on, said first SBG is inactive and said second SBG is active, wherein said light transmitted in said common direction illuminates said microdisplay,
wherein said microdisplay modulates said first polarisation output light with left eye perspective image data,
wherein said microdisplay modulates said second polarisation output light with right eye perspective image data.

14. An illumination device comprising:
a first light source emitting light at a first wavelength and a first angle;
a second light source emitting light at said first wavelength and a second angle;
a first SBG operative to diffract said first wavelength light;
a second SBG identical to said first SBG operative to diffract said first wavelength light;
a quarter wave plate; and
a microdisplay,
wherein each said SBG is operative to diffract light of a first polarization and transmit light of a second orthogonal polarization when in an active state and transmit light of any polarization without deviation when in an inactive state,
characterised in that said light sources are operated pulse sequentially,
wherein said first and second SBGs are activated cyclically,
wherein said first SBG when in its active state diffracts said first polarization light from said first source into an illumination path towards said microdisplay,
wherein said second SBG when in its active state diffracts said first polarization light from said second source out of said illumination path,
wherein said microdisplay modulates said first polarisation output light with left eye perspective image data,
wherein said microdisplay modulates said second polarisation output light with right eye perspective image data.
